(19) United States
(12) Patent Application Publication
(10) Pub. No.: US 2024/0014727 A1
(43) Pub. Date: Jan. 11, 2024

(54) POWER CONTROL DEVICE AND FLYBACK CONVERTER

(71) Applicant: Rohm Co., Ltd., Kyoto (JP)

(72) Inventor: Hiroki KIKUCHI, Kyoto (JP)

(21) Appl. No.: 18/037,426

(22) PCT Filed: Nov. 22, 2021
(86) PCT No.: PCT/JP2021/042766

§ 371 Date: May 17, 2023

(30) Foreign Application Priority Data
Dec. 16, 2020 (JP) 2020-208251
Dec. 29, 2020 (JP) 2020-219832

(51) Int. Cl. H02M 1/08; H02M 3/335; H02M 1/00

(52) U.S. Cl. CPC H02M 1/08; H02M 3/33515; H02M 1/0012; H02M 1/0009

(57) ABSTRACT

A power control device (40) includes a feedback voltage generator (401), which generates as a differential current (I_DF) the difference between a first current (I_VDS) generated by a first resistor (59) having one terminal connectable to a current input terminal (DRAIN terminal) and a second current (I_VH) generated by a second resistor (58) having one terminal connectable to an application terminal for an input voltage (VIN) and which generates a feedback voltage (V1) based on the differential current generated.

### TECHNICAL FIELD

The present disclosure relates to power control devices for flyback converters.

### BACKGROUND ART

Flyback converters are known as switching power supply circuits for use in isolated DC/DC converters or isolated AC-DC converters (see, for example, Patent Document 1 identified below). A flyback converter chops a DC input voltage with a switching transistor and transmits energy via a transformer to the secondary side.

### CITATION LIST

### Patent Literature

Patent Document 1: JP-A-2003-209971

### Technical Problem

With some flyback converters it is preferable to perform feedback of the output voltage in the primary side to control the output voltage.

A first object of the present disclosure is to provide a power control device that achieves feedback of the output voltage in the primary side with an effective configuration.

A second object of the present disclosure is to provide a power control device with improved performance in the control of the output voltage with respect to the load based on feedback of the output voltage in the primary side.

### Solution to Problem

According to one aspect of the present disclosure, a power control device includes:
a switching element;
a transformer having a primary winding and a secondary winding;
a rectifying element; and
a smoothing capacitor,
one terminal of the primary winding being connected to an application terminal for an input voltage,
the other terminal of the primary winding being connected to the current input terminal of the switching element,
the rectifying element and the smoothing capacitor being provided in a stage succeeding the secondary winding,
the power control device being for use in a flyback converter,
wherein
the power control device further includes:
a feedback voltage generator configured to
   generate a differential current that is the difference between
      a first current generated by a first resistor having one terminal connectable to the current input terminal and
      a second current generated by a second resistor having one terminal connectable to the application terminal for the input voltage and
   generate a feedback voltage based on the differential current generated.

According to another aspect of the present disclosure, a power control device includes:
a switching element;
a transformer having a primary winding and a secondary winding;
a rectifying element; and
a smoothing capacitor,
one terminal of the primary winding being connected to an application terminal for an input voltage,
the other terminal of the primary winding being connected to the current input terminal of the switching element,
the rectifying element and the smoothing capacitor being provided in a stage succeeding the secondary winding,
the power control device being for use in a flyback converter,
wherein
the power control device further includes:
a feedback voltage generator configured to generate a feedback voltage based on the flyback voltage appearing in the primary winding when the switching element is off;
a sample-and-hold circuit configured to sample the feedback voltage;
a switching controller configured to control the switching of the switching element based on the voltage output from the sample-and-hold circuit and a reference voltage; and
a sampling timing feeder configured to
   detect, based on the input voltage, the flyback voltage, and the on period of the switching element, the secondary-side current zero timing at which the secondary-side current passing in the secondary winding when the switching element is off ceases to pass and
   control the sample-and-hold circuit based on the secondary-side current zero timing detected.

### Advantageous Effects of Invention

With a power control device according to the present disclosure, it is possible to achieve feedback of the output voltage in the primary side with an effective configuration. With a power control device according to the present disclosure, it is possible to improve performance in the control of the output voltage with respect to the load based on feedback of the output voltage in the primary side

### BRIEF DESCRIPTION OF DRAWINGS

FIG. 1 is a diagram showing the configuration of a flyback converter of Comparative Example 1.

FIG. 2 is a timing chart showing an example of the operation of the flyback converter of Comparative Example 1.

FIG. 3 is a diagram showing the configuration of a flyback converter of Comparative Example 2.

FIG. 4 is a timing chart showing an example of the operation of the flyback converter of Comparative Example 2.

FIG. 5 is a diagram showing the configuration of a flyback converter according to an illustrative embodiment of the present disclosure.

FIG. 6 is a timing chart showing an example of the operation of the flyback converter according to the illustrative embodiment of the present disclosure.

FIG. 7 is a diagram showing the configuration of a flyback converter according to a modified example of the present disclosure.

FIG. 8 is a diagram showing the configuration of a flyback converter according to another modified example of the present disclosure.

FIG. 9 is a diagram showing the configuration of a flyback converter of Comparative Example.

FIG. 10 is a timing chart showing an example of the operation of the flyback converter of Comparative Example.

FIG. 11 is a timing chart illustrating how the timing of sampling is determined.

FIG. 12 is a diagram showing the configuration of a flyback converter according to an embodiment of the present disclosure.

FIG. 13 is a timing chart showing an example of the waveforms of relevant signals during stable operation of the flyback converter according to the embodiment of the present disclosure

FIG. 14 is a timing chart showing an example of the waveforms of relevant signals during unstable operation of the flyback converter according to the embodiment of the present disclosure.

FIG. 15 is a diagram showing a modified example of the configuration related to output of the timing of sampling.

FIG. 16 is a timing chart showing an example of the operation of the configuration according to the modified example shown in FIG. 15.

### DESCRIPTION OF EMBODIMENTS

Illustrative embodiments of the present disclosure will be described below with reference to the accompanying drawings.

### Technical Scheme I

Technical Scheme I will be described below.

### 1. Comparative Example 1

Prior to a description of embodiments of the present disclosure, comparative examples for comparison with them will be described. The benefits of what is disclosed herein will become clear by comparison with these comparative examples.

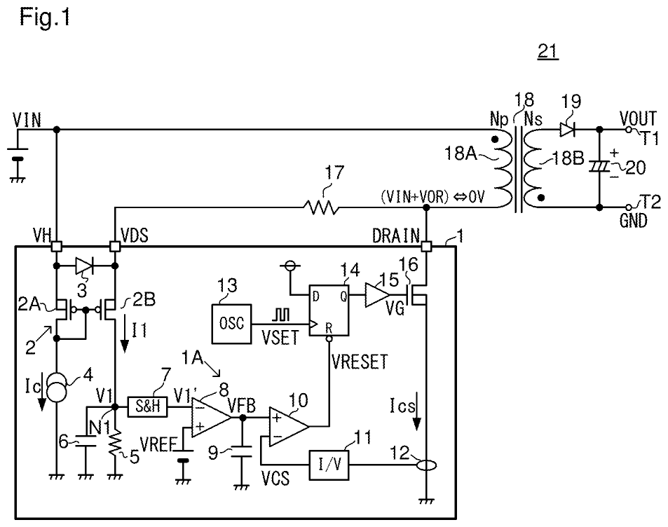

FIG. 1 shows the configuration of a flyback converter 21 of Comparative Example 1. The flyback converter 21 is configured as an isolated DC/DC converter, and performs DC/DC conversion, that is, converts an input voltage VIN (e.g., 48 V), which is a DC voltage, into an output voltage VOUT (e.g., 5 V), which is a DC voltage.

As shown in FIG. 1, the flyback converter 21 includes a power control device 1, a resistor 17, a transformer 18, a rectifying diode 19, and a smoothing capacitor 20. The power control device 1 is a semiconductor device (semiconductor package) having the internal circuit elements shown in FIG. 1 integrated into a single chip. The resistor 17, the transformer 18, the rectifying diode 19, and the smoothing capacitor 20 are discrete circuit elements that are arranged outside the power control device 1.

The power control device 1 includes a current mirror 2, a diode 3, a constant current source 4, a resistor 5, a capacitor 6, a sample-and-hold circuit 7, an error amplifier 8, a capacitor 9, a comparator 10, an I/V converter 11, a current sensor 12, an oscillator 13, a flip-flop 14, a driver 15, and a switching element 16. The switching element 16 may be externally connected to the power control device.

The power control device 1 further has, as external terminals for electrical connection with the outside, a VH terminal, a VDS terminal, and a DRAIN terminal.

The VH terminal is connected to an application terminal for the input voltage VIN. The transformer 18 has a primary winding 18A and a secondary winding 18B. One terminal of the primary winding 18A is connected to the application terminal for the input voltage VIN. The other terminal of the primary winding 18A is connected to the DRAIN terminal and to one terminal of the resistor 17. The other terminal of the resistor 17 is connected to the VDS terminal.

One terminal of the secondary winding 18B is connected to the anode of the rectifying diode 19. The cathode of the rectifying diode 19 is connected to one terminal of the smoothing capacitor 20 and to an output terminal T1. The other terminal of the secondary winding 18B is connected to the other terminal of the smoothing capacitor 20 and to a ground terminal T2. The ground terminal T2 is connected to an application terminal for a ground potential.

The current mirror 2 is composed of PMOS transistors 2A and 2B. The source of the PMOS transistor 2A is connected to the VH terminal. The gate of the PMOS transistor 2A is short-circuited to the drain of the PMOS transistor 2A. Between the drain of the PMOS transistor 2A and the ground, the constant current source 4 is arranged. The gate of the PMOS transistor 2A and the gate of the PMOS transistor 2B are connected together. The source of the PMOS transistor 2B is connected to the VDS terminal. The drain of the PMOS transistor 2B is, along with one terminal of the resistor 5, connected, at a node N1, to one terminal of the capacitor 6. The other terminal of the resistor 5 and the other terminal of the capacitor 6 are both connected to the application terminal for the ground potential.

In the stage succeeding the node N1, the sample-and-hold circuit 7 is arranged. The sample-and-hold circuit 7 performs sampling and holding. In sampling, it outputs an analog input unchanged as an analog output; in holding, it holds an analog input as it is immediately before switching from sampling and outputs it as an analog output. The sample-and-hold circuit 7 operates with, as an analog input, a pre-sampling feedback voltage V1 appearing at the node N1 and, as an analog output, a post-sampling feedback voltage V1′.

A switching controller 1A is constituted by the error amplifier 8, the capacitor 9, the comparator 10, the I/V converter 11, the current sensor 12, the oscillator 13, the flip-flop 14, and the driver 15. The switching controller 1A controls the switching of the switching element 16 (turns it on and off) based on the post-sampling feedback voltage V1′.

The inverting input terminal (−) of the error amplifier 8 is fed with the post-sampling

feedback voltage V1′ output from the sample-and-hold circuit 7. The non-inverting input terminal (+) of the error amplifier 8 is fed with a reference voltage VREF. The error amplifier 8 amplifies the error between the post-sampling feedback voltage V1′ and the reference voltage VREF and thereby generates an error signal VFB. The output terminal of the error amplifier 8 is connected to one terminal of the capacitor 9. The other terminal of the capacitor 9 is connected to the application terminal for the ground potential.

The non-inverting input terminal (+) of the comparator 10 is fed with the error signal VFB. The I/V converter 11 performs I/V conversion (current-to-voltage conversion) on a sense signal resulting from the current sensor 12 sensing the current Ics passing between the drain and source of the switching element 16, which will be described later, and thereby generates a current sense signal VCS. The inverting input terminal (−) of the comparator 10 is fed with the current sense signal VCS. The comparator 10 compares the error signal VFB and the current sense signal VCS to output, as a comparison result, a reset signal VRESET.

The flip-flop 14 is configured as a D flip-flop. The D terminal of the flip-flop 14 is fed with a supply voltage. The clock terminal of the flip-flop 14 is fed with, as a set signal VSET, an oscillation signal output from the oscillator 13. The set signal VSET (oscillation signal) is a pulse signal with a fixed period. The reset terminal of the flip-flop 14 is fed with the reset signal VRESET.

The signal output from the Q output terminal of the flip-flop 14 is fed to the driver 15. Based on the output signal from the Q output terminal, the driver 15 generates a gate signal VG. The switching element 16 is configured with an NMOS transistor. The drain (current input terminal) of the switching element 16 is connected to the DRAIN terminal. The source of the switching element 16 is connected to the application terminal for the ground potential. The gate signal VG is fed to the gate of the switching element 16.

Between the sources of the PMOS transistors 2A and 2B (between the VH and VDS terminals), the diode 3 for clamping is connected. Specifically, to the source of the PMOS transistor 2A, the anode of the diode 3 is connected, and to the source of the PMOS transistor 2B, the cathode of the diode 3 is connected.

Owing to the diode 3, even if the DRAIN terminal is short-circuited to the ground potential, the voltage at the VDS terminal is clamped at a voltage that is lower than the voltage at the VH terminal (i.e., the input voltage VIN) by the forward voltage across the diode 3. It is thus possible to prevent too low a voltage at the VDS terminal from resulting in too high a gate-source voltage in the PMOS transistor 2A.

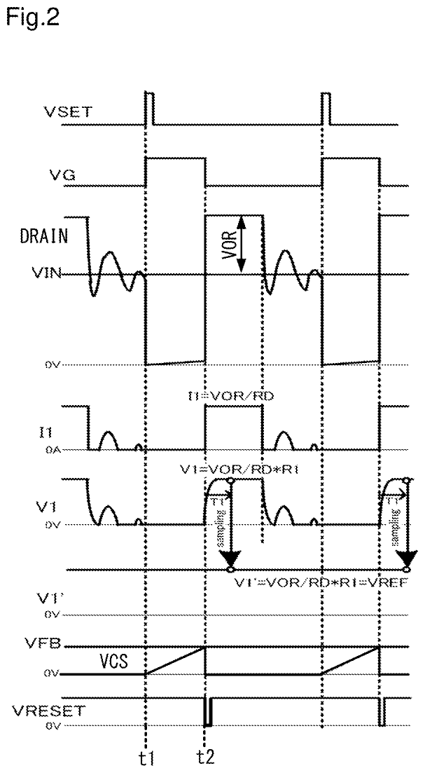

Next, the operation of the flyback converter 21 configured as described above will be described with reference to a timing chart in FIG. 2. FIG. 2 shows an example of the waveforms of, from top down, the set signal VSET, the gate signal VG, the voltage at the DRAIN terminal, a current I1, the pre-sampling feedback voltage V1, the post-sampling feedback voltage V1′, the error signal VFB, the current sense signal VCS, and the reset signal VRESET. The current I1 is, as shown in FIG. 1, a current that passes through the VDS terminal (the PMOS transistor 2B).

As shown in FIG. 2, when at time point t1 the set signal VSET (oscillation signal) rises, the output at the Q output terminal of the flip-flop 14 rises to high, and the gate signal VG output from the driver 15 rises to high. Thus the switching element 16 is turned on.

Then the voltage at the DRAIN terminal falls to 0 V, and the current Ics through the switching element 16 increases from 0 A. Thus the current sense signal VCS increases from 0 V. Magnetically induced energy accumulates in the primary winding 18A, and the rectifying diode 19 is off.

With the switching element 16 on, the voltage at the DRAIN terminal is nearly 0 V and, with the voltage at the VDS terminal clamped at a voltage lower than the input voltage VIN by the forward voltage across the diode 3, a current passes through the resistor 17 from the VDS terminal to the DRAIN terminal. Thus the current I1 does not pass (I1=0 V). Accordingly the pre-sampling feedback voltage V1, which is generated from the current I1 through I/V conversion by the resistor 5, equals 0 V.

When at time point t2 the current sense signal VCS becomes higher than the error signal VFB, the reset signal VRESET turns low, and the flip-flop 14 is reset. Thus the output at the Q output terminal of the flip-flop 14 falls to low, and the gate signal VG output from the driver 15 falls to low. Thus the switching element 16 is turned off.

That turns on the diode 19 and the magnetically induced energy is released. This produces a flyback voltage VOR in the primary winding 18A. The flyback voltage VOR is given by VOR=(VOUT+VF)×(Np/Ns), where VF is the forward voltage across the rectifying diode 19, Np is the number of turns of the primary winding 18A, and Ns is the number of turns of the secondary winding 18B.

Thus the voltage at the DRAIN terminal rises to VIN+VOR. Here, the voltage at the VDS terminal is a voltage equal to the voltage at the VH terminal (=VIN) minus the gate-source voltage of the PMOS transistor 2A plus the gate-source voltage of the PMOS transistor 2B. Accordingly, the voltage at the VDS terminal equals VIN, and the voltage applied to the resistor 17 equals (VIN+VOR)−VIN=VOR. Thus the current I1 equals VOR/RD, where RD is the resistance value of the resistor 17.

Here, the pre-sampling feedback voltage V1 equals I1×R1=(VOR/RD)×R1, where R1 is the resistance value of the resistor 5. With the switching element 16 off, the sample-and-hold circuit 7 performs sampling on the pre-sampling feedback voltage V1 to output the post-sampling feedback voltage V1′. After sampling, the sample-and-hold circuit 7 performs holding; it thus holds the post-sampling feedback voltage V1′.

The switching controller 1A generates the gate signal VG for PWM control such that the post-sampling feedback voltage V1′ equals the reference voltage VREF, and thereby controls the switching of the switching element 16. In this way, based on the flyback voltage VOR, which includes information on the output voltage VOUT, the feedback voltage V1 is generated and, based on the feedback voltage V1, the switching of the switching element 16 is controlled; thus the output voltage VOUT is controlled.

Inconveniently, the power control device 1 of Comparative Example 1 configured as described above has the following shortcomings. The first shortcoming: when the power control device 1 is used in an isolated AC/DC converter, the input voltage VIN generated based on an AC voltage is comparatively high (e.g., 400 V), and thus the PMOS transistors 2A and 2B needs to be implemented with ones with a high withstand voltage (e.g., 650 V), leading to an increased size of the transistors.

The second shortcoming: in case the DRAIN terminal is short-circuited to the ground potential, the diode 3 for clamping is necessary.

The third shortcoming: the diode 3 and the PMOS transistor 2B cause a comparatively high parasitic capacitance to be connected to the VDS terminal, and this results in a high time constant in the low-pass filter constituted by the resistor 17 and the parasitic capacitance, producing a delay in the rising of the feedback voltage V1 compared with the rising of the voltage at the DRAIN terminal from 0 V to VIN+VOR. This requires that, for example as shown in FIG. 2, the sampling of the feedback voltage V1 be performed at the lapse of a period T1 determined with consideration given to the delay from time point t2 at which the switching element 16 turns off. This restricts the timing of the sampling.

### 2. Comparative Example 2

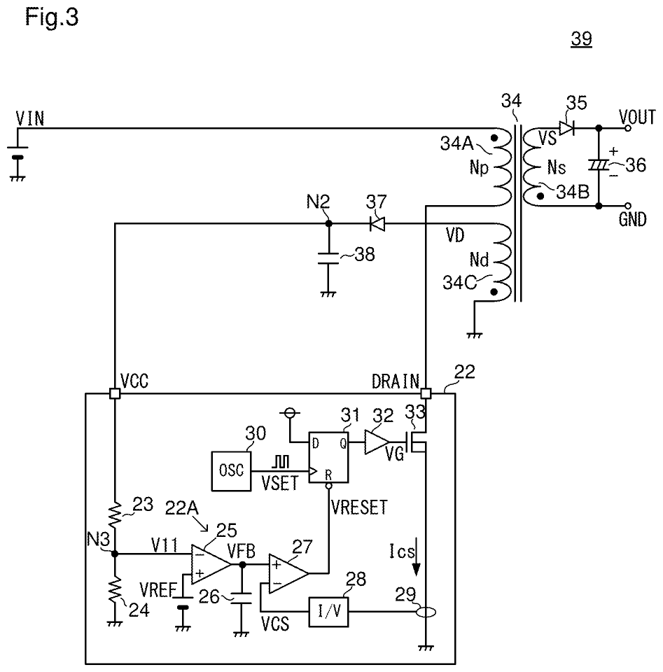

FIG. 3 shows the configuration of a flyback converter 39 of Comparative Example 2. The flyback converter 39 is configured to be included in an isolated AC/DC converter. The isolated AC/DC converter includes a diode bridge and a smoothing capacitor (neither is illustrated) in the stage preceding what is shown in FIG. 3. An AC voltage is rectified with the diode bridge and smoothed with the smoothing capacitor and thereby an input voltage VIN, which is the DC voltage shown in FIG. 3, is generated. The flyback converter 39 performs DC/DC conversion, that is, converts the input voltage VIN (e.g., 400 V) to an output voltage VOUT (e.g., 5 V).

As shown in FIG. 3, the flyback converter 39 includes a power control device 22, a transformer 34, a rectifying diode 35, a smoothing capacitor 36, a rectifying diode 37, and a smoothing capacitor 38. The transformer 34, the rectifying diode 35, the smoothing capacitor 36, the rectifying diode 37, and the smoothing capacitor 38 are discrete circuit elements that are arranged outside the power control device 22. The transformer 34 has a primary winding 34A, a secondary winding 34B, and a primary-side auxiliary winding 34C.

The power control device 22 includes resistors 23 and 24 for voltage division and a switching controller 22A. The power control device 22 further has, as external terminals, a VCC terminal and a DRAIN terminal.

Comparative Example 2 differs from Comparative Example 1 in the configuration around the VCC terminal, the resistors 23 and 24, the auxiliary winding 34C, the rectifying diode 37, and the smoothing capacitor 38. One terminal of the auxiliary winding 34C is connected to the anode of the rectifying diode 37. The cathode of the rectifying diode 37 is connected to one terminal of the smoothing capacitor 38. The other terminal of the auxiliary winding 34C is connected to an application terminal for a ground potential. A node N2 to which the cathode of the rectifying diode 37 and the smoothing capacitor 38 are connected is connected to the VCC terminal. The resistors 23 and 24 are connected in series between the VCC terminal and the application terminal for the ground potential. The resistors 23 and 24 are connected together at a node N3. The resistors 23 and 24 divide the voltage at the VCC terminal to produce a feedback voltage V11 at the node N3.

The switching controller 22A includes an error amplifier 25, a capacitor 26, a comparator 27, an I/V converter 28, a current sensor 29, an oscillator 30, a flip-flop 31, and a driver 32. Based on the feedback voltage V11, the switching controller 22A controls the switching of a switching element 33.

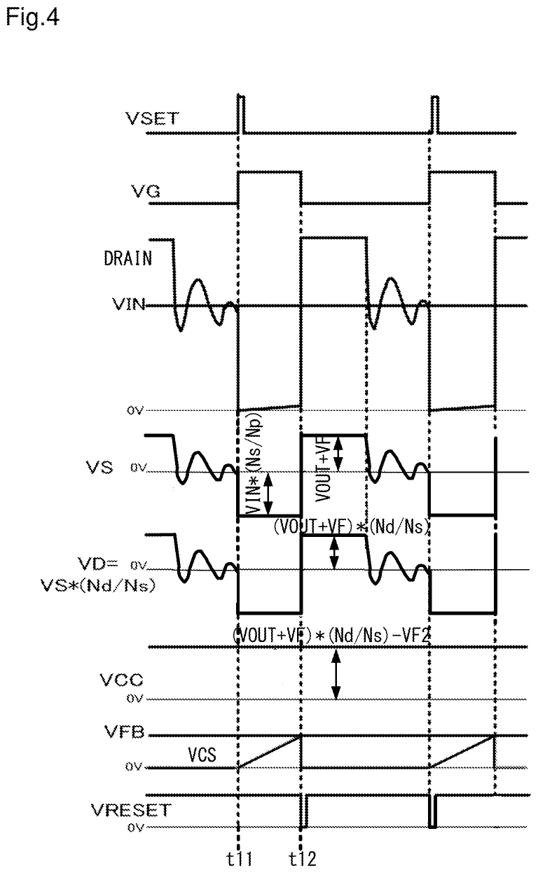

The operation of the flyback converter 39 of Comparative Example 2 configured as described above will be described with reference to a timing chart in FIG. 4. FIG. 4 shows the waveforms of, from top down, the set signal VSET, the gate signal VG, the voltage at the DRAIN terminal, a secondary winding voltage VS, an auxiliary winding voltage VD, the voltage at the VCC terminal, the error signal VFB, the current sense signal VCS, and the reset signal VRESET.

When at time point t11 the gate signal VG rises to high and the switching element 33 is turned on, the secondary winding voltage VS equals−VIN×(Ns/Np). Here, the auxiliary winding voltage VD equals VD=VS×(Nd/Ns), where Nd is the number of turns of the auxiliary winding 34C. The auxiliary winding voltage VD is rectified with the rectifying diode 37 and smoothed with the smoothing capacitor 38 and thereby the voltage at the VCC terminal is produced.

When at time point t12 the switching element 33 is turned off, VS=VOUT+VF, and thus VD=(VOUT+VF)×(Nd/Ns). Rectifying and smoothing the auxiliary winding voltage VD results in the voltage at the VCC terminal being equal to (VOUT+VF)×(Nd/Ns)−VF2, where VF2 is the forward voltage across the rectifying diode 37.

Thus the feedback voltage V11 generated from the voltage at the voltage through voltage division by the resistors 23 and 24 includes information on the output voltage VOUT. The switching controller 22A generates the gate signal VG for PWM control such that the feedback voltage V11 equals the reference voltage VREF, and thereby the switching of the switching element 33 is controlled; thus the output voltage VOUT is controlled.

With Comparative Example 2 configured as described above, even in an application in an isolated AC/DC converter where the input voltage VIN is comparatively high, the power control device 22 does not require high-withstand-voltage PMOS transistors as are required in Comparative Example 1. Even so, Comparative Example 2 has a fourth shortcoming: the use of the auxiliary winding 34C leads to an increased cost and an increased size of the transformer 34.

### 3. Embodiment of the Present Disclosure

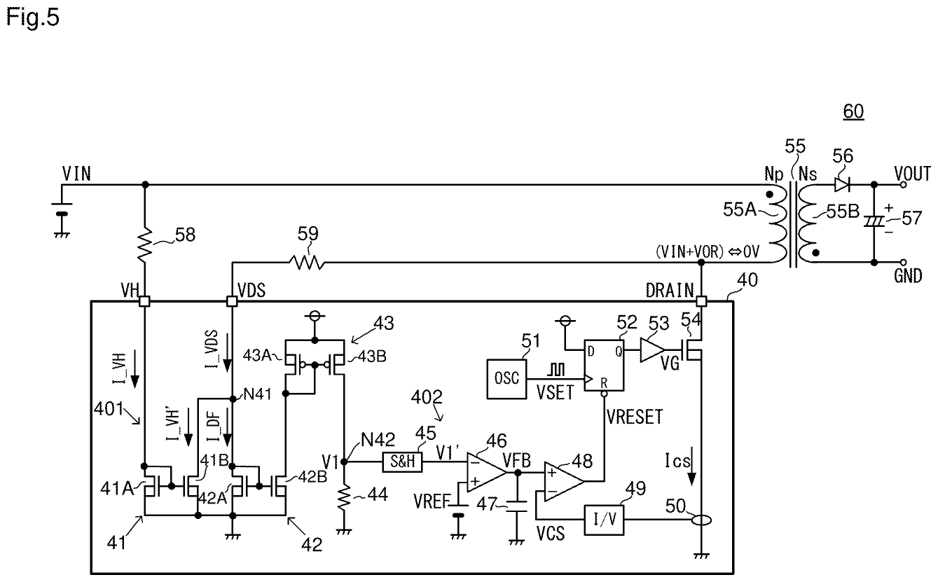

FIG. 5 shows the configuration of a flyback converter 60 according to an embodiment of the present disclosure. As will be described later, the flyback converter 60 is suitable for both isolated DC/DC converters and isolated AC/DC converters.

As shown in FIG. 5, the flyback converter 60 includes a power control device 40, a transformer 55, a rectifying diode 56, a smoothing capacitor 57, and resistors 58 and 59. The transformer 55, the rectifying diode 56, the smoothing capacitor 57, and the resistors 58 and 59 are discrete circuit elements that are arranged outside the power control device 40.

The power control device 40 includes, integrated in it, a feedback voltage generator 401, a switching controller 402, and a switching element 54.

The feedback voltage generator 401 includes current mirrors 41 to 43 and a resistor 44, and generates the feedback voltage V1.

The switching controller 402 includes a sample-and-hold circuit 45, an error amplifier 46, a capacitor 47, a comparator 48, an I/V converter 49, a current sensor 50, an oscillator 51, a flip-flop 52, and a driver 53. Base on the feedback voltage V1, which is generated as described later, the switching controller 402 controls the switching of a switching element 54.

The power control device 40 further has, as external terminals, a VH terminal, a VDS terminal, and a DRAIN terminal.

The following description focuses on differences in configuration from Comparative Example 1 (FIG. 1) described previously. In the flyback converter 60, one terminal of the resistor 58 is connected to an application terminal for the input voltage VIN, and the other terminal of the resistor 58 is connected to the VH terminal. One terminal of the resistor 59 is, along with a primary winding 55A of the transformer 55, connected to the DRAIN terminal. The other terminal of the resistor 59 is connected to the VDS terminal.

The current mirror 41 is composed of NMOS transistors 41A and 41B. Specifically, the drain of the NMOS transistor 41A is connected to the VH terminal. The gate and drain of the NMOS transistor 41A are short-circuited together. The source of the NMOS transistor 41A is connected to an application terminal for a ground potential. The gates of the NMOS transistors 41A and 41B are connected together. The source of the NMOS transistor 41B is connected to the application terminal for the ground potential.

The current mirror 42 is composed of NMOS transistors 42A and 42B. Specifically, the drain of the NMOS transistor 42A is, along with the drain of the NMOS transistor 41B, connected, at a node N41, to the VDS terminal. The gate and drain of the NMOS transistor 42A are short-circuited together. The source of the NMOS transistor 42A is connected to the application terminal for the ground potential. The gates of the NMOS transistors 42A and 42B are connected together. The source of the NMOS transistor 42B is connected to the application terminal for the ground potential.

The current mirror 43 is composed of PMOS transistors 43A and 43B. Specifically, the drain of the PMOS transistor 43A is connected to the drain of the NMOS transistor 42B. The gate and drain of the PMOS transistor 43A are short-circuited together. The gates of the PMOS transistors 43A and 43B are connected together. The sources of the PMOS transistors 43A and 43B are both connected to an application terminal for a supply voltage.

The drain of the PMOS transistor 43B is connected, at a node N42, to one terminal of the resistor 44. The other terminal of the resistor 44 is connected to the application terminal for the ground potential. At the node N42, the pre-sampling feedback voltage V1 appears. The pre-sampling feedback voltage V1 is fed to the sample-and-hold circuit 45.

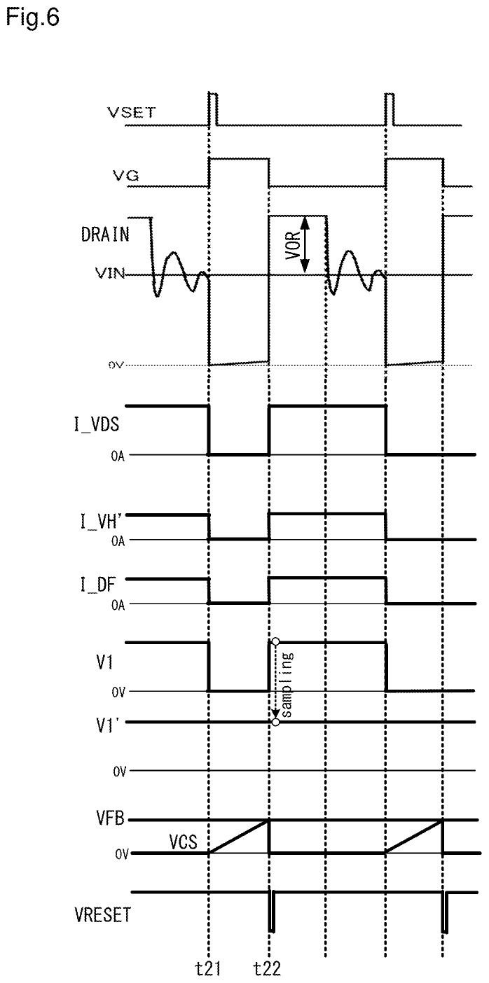

The operation of the flyback converter 60 configured as described above will be described with reference to a timing chart in FIG. 6. FIG. 6 shows an example of the waveforms of, from top down, the set signal VSET, the gate signal VG, the voltage at the DRAIN terminal, a current I_VDS, a current I_VH′, a current I_DF, the pre-sampling feedback voltage V1, the post-sampling feedback voltage V1′, the error signal VFB, the current sense signal VCS, and the reset signal VRESET.

As shown in FIG. 5, the current I_VDS is a current that passes through the VDS terminal. The current I_VH′ is a current that is output from the current mirror 41 fed with, as the input to it, the current I_VH that passes through the VH terminal. The current I_DF is a current that corresponds to the difference between the currents I_VDS and I_VH′.

As shown in FIG. 6, when at time point t21 the gate signal VG rises to high and the switching element 54 is turned on, the voltage at the DRAIN terminal falls to 0 V. Thus the currents I_VDS and IVH′ are both 0 A and hence the current I_DF too is 0 A. Accordingly the pre-sampling feedback voltage V1 appearing at the node N42 is 0 V.

With the switching element 54 on, when the current sense signal VCS rises until at time point t22 it becomes higher than the error signal VFB, the reset signal VRESET falls to low and the gate signal VG falls to low. Thus the switching element 54 is turned off.

Then, based on the flyback voltage VOR appearing in the primary winding 55A, the voltage at the DRAIN terminal equals VIN+VOR. Thus the current I_VDS equals (VIN+VOR)/RD1, where RD1 is the resistance value of the resistor 59.

On the other hand, the current I_VH′ equals VIN/RD2, where RD2 is the resistance value of the resistor 58. Accordingly, if the resistance values RD1 and RD2 are equal such that RD1=RD2=RD, then the current I_DF equals (VIN+VOR)/RD1−VIN/RD2=VOR/RD.

Thus the pre-sampling feedback voltage V1, which is generated, through I/V conversion by the resistor 44, from the current output through the current mirrors 42 and 43 based on the current I_DF, includes information on VOR. Since VOR=(VOUT+VF)×(Np/Ns), where VF is the forward voltage across the rectifying diode 56, the pre-sampling feedback voltage V1 includes information on VOUT.

As shown in FIG. 6, through the sampling of the pre-sampling feedback voltage V1 by the sample-and-hold circuit 45 with the switching element 54 off, the post-sampling feedback voltage V1′ is produced. The circuit elements in the stage succeeding the sample-and-hold circuit 45 in the switching controller 402 generates the gate signal VG for PWM control such that the post-sampling feedback voltage V1′ equals the reference voltage VREF and thereby the switching of the switching element 54 is controlled; thus the output voltage VOUT is controlled.

As described above, with the power control device 40 according to this embodiment, as in Comparative Examples 1 and 2, it is possible to perform feedback of the output voltage VOUT in the primary side. Comparative Example 1 in particular requires high-withstand-voltage PMOS transistors and is not suitable for isolated AC/DC converters; by contrast, with the power control device 40 according to this embodiment, even if the input voltage VIN is comparatively high, the NMOS transistors 41A, 41B, and 42A only need to have a withstand voltage comparable with a gate-source voltage and can be implemented with low-withstand-voltage devices with a small size. The NMOS transistor 42B and the PMOS transistors 43A and 43B too can be implemented with low-withstand-voltage devices.

Comparative Example 2 is more suitable for isolated AC/DC converters than Comparative Example 1, but even so has a shortcoming of requiring an auxiliary winding in the transformer. By contrast, this embodiment requires no auxiliary winding in the transformer. Thus this embodiment is suitable for isolated AC/DC converters.

Although Comparative Example 1 is comparatively suitable for isolated DC/DC converters, it requires a diode for clamping in case of a short circuit between the DRAIN terminal and the ground potential. By contrast, the power control device 40 according to this embodiment does not require such a diode for clamping.

Comparative Example 1 also has a shortcoming of a comparatively large delay in the rising of the feedback voltage at the turning-off of the switching element. By contrast, with the power control device 40 according to this embodiment, the NMOS transistor 42A in the input side of the current mirror 42 corresponds to a diode and the NMOS transistor 42A has a low impedance. Moreover, the parasitic capacitance connected to the VDS terminal is low. This improves the response of the rising of the pre-sampling feedback voltage V1 to the rising of the voltage at the DRAIN terminal to VIN+VOR at the turning-off of the switching element 54. This alleviates the restriction on the timing of the sampling of the pre-sampling feedback voltage V1. Thus this embodiment is suitable also for insulated DC/DC converter.

As seen in VOR=(VOUT+VF)×(Np/Ns), VOR includes VF; with this taken into consideration, the resistance value RD1 of the resistor 59 may be adjusted to be different from the resistance value RD2 of the resistor 58. That is, RD1 and RD2 need not be equal.

### 4. Modified Example

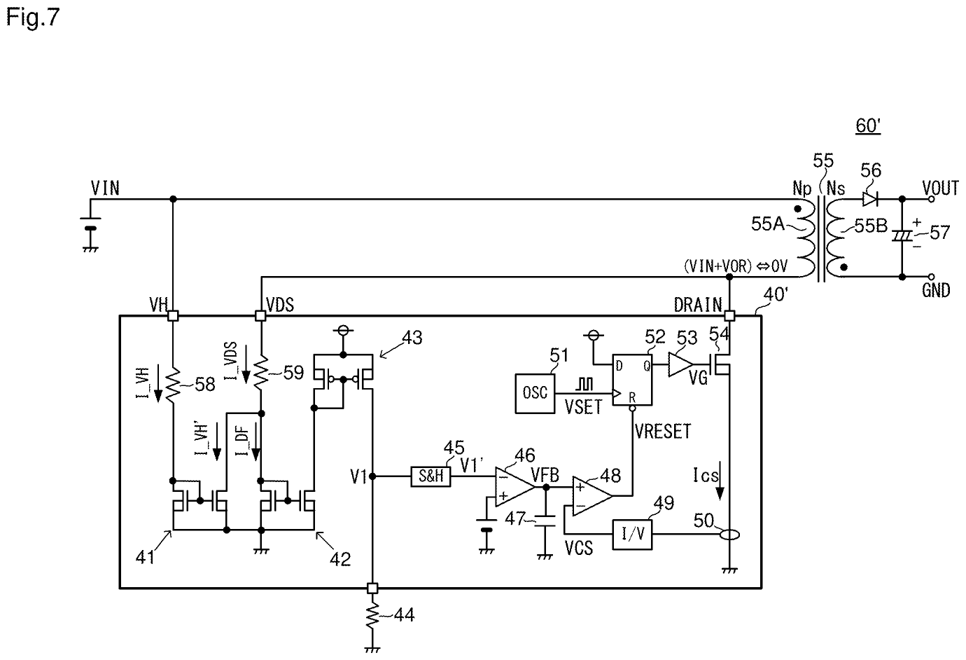

FIG. 7 shows the configuration of a flyback converter 60′ as a modified example of the embodiment (FIG. 5) described previously. In the configuration in FIG. 7, the resistors 58 and 59 are incorporated in a power control device 40′ and the resistor 44 is externally connected to the power control device 40′.

With a configuration as shown in FIG. 5 where the resistors 58 and 59 are externally connected, they may be short-circuited across their terminals, in which case the NMOS transistors 41A, 41B, and 42A may be exposed to a voltage higher than their withstand voltage. Incorporating the resistors 58 and 59 as in FIG. 7 makes them less likely to be short-circuited across their terminals. It should however be noted that externally connecting the resistors 58 and 59 allows easy adjustment of their resistance values and permits use of high-withstand-voltage resistors.

On the other hand, the resistor 44 may be externally connected as shown in FIG. 7. This allows easy adjustment of the I/V conversion for generating the pre-sampling feedback voltage V1.

### 5. Other Modifications

The embodiments of the present disclosure described above allow for any modifications without departure from the spirit of what is disclosed herein.

For example, the rectifying element in the secondary side is not limited to the rectifying diode 56 shown in FIG. 5 and described above and may be implemented with a rectifying diode of which the cathode is connected to the other terminal of the transformer 55 and of which the anode is connected to the ground terminal.

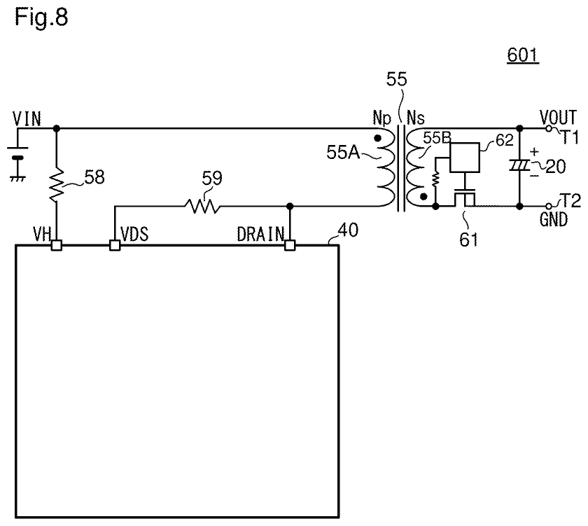

Or as in the flyback converter 601 shown in FIG. 8, a synchronous rectification transistor 61 may be used as the rectifying element in the secondary side. In that case, together with the synchronous rectification transistor 61, a synchronous rectification controller 62 is provided in the secondary side. The synchronous rectification controller 62 controls the switching of the synchronous rectification transistor 61 in synchronization with the switching element in the primary side (not illustrated in FIG. 8; one similar to the switching element 54 in FIG. 5).

### 6. Notes

As described above, according to one aspect of the present disclosure, a power control device (40) includes: a switching element (54); a transformer (55) having a primary winding (55A) and a secondary winding (55B); a rectifying element (56); and a smoothing capacitor (57).

One terminal of the primary winding is connected to an application terminal for an input voltage (VIN).

The other terminal of the primary winding is connected to the current input terminal of the switching element.

The rectifying element and the smoothing capacitor are provided in a stage succeeding the secondary winding, and the power control device being for use in a flyback converter (60).

Here, the power control device further includes a feedback voltage generator (401), which generates as a differential current (I_DF) the difference between a first current (I_VDS) generated by a first resistor (59) having one terminal connectable to the current input terminal and a second current (I_VH) generated by a second resistor (58) having one terminal connectable to the application terminal for the input voltage and which generates a feedback voltage (V1) based on the differential current generated. (A first configuration.)

In the first configuration described above, the feedback voltage generator (401) may include: a first current mirror (41) which has having an input terminal connectable to the other terminal of the second resistor (58) and which is configured with NMOS transistors (41A, 41B); a second current mirror (42) which has an input terminal connected to the output terminal of the first current mirror and to the other terminal of the first resistor and which is configured with NMOS transistors (42A, 42B); a third current mirror (43) which has having an input terminal connected to the output terminal of the second current mirror and which is configured with PMOS transistors (43A, 43B); and a third resistor (44) having one terminal connected to the output terminal of the third current mirror. (A second configuration.)

In the first or second configuration described above, the first and second resistors (59 and 58) may have equal resistance values. (A third configuration.)

In the first or second configuration described above, the first and second resistors (59 and 58) may have different resistance values. (A fourth configuration.)

In any of the first to fourth configurations described above, at least one of the first and second resistors (59 and 58) may be externally connectable to the power control device (40). (A fifth configuration.)

In any of the first to fourth configurations described above, at least one of the first and second resistors (59 and 58) may be incorporated in the power control device (40′). (A sixth configuration.)

In the second configuration described above, the third resistor (44) may be externally connectable to the power control device (40′). (A seventh configuration.)

In any of the first to seventh configurations described above, there may be further provided a switching controller (402) which includes a sample-and-hold circuit (45) for sampling the feedback voltage (V1) when the switching element (54) is off and which controls the switching of the switching element based on the voltage (V1′) output from the sample-and-hold circuit and a reference voltage (VREF). (An eighth configuration.)

According to another aspect of the present disclosure, a flyback converter (60) includes: the power control device (40) of any of the first to eighth configuration described above; the switching element (54); the transformer (55); the rectifying element (56); the smoothing capacitor (57); and the first and second resistors (59 and 58).

### Technical Scheme II

Technical Scheme II will be described below. It should be noted that the reference signs used to identify circuit elements and signals in the following description are unrelated to those used for Technical Scheme I.

### 1. Comparative Example

Prior to a description of embodiments of the present disclosure, a comparative example for comparison with them will be described. The benefits of what is disclosed herein will become clear by comparison with this comparative example.

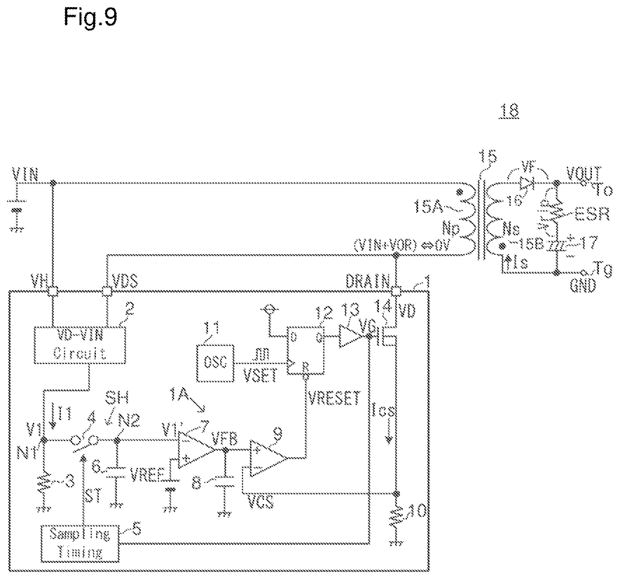

FIG. 9 shows the configuration of a flyback converter 18 of the comparative example. The flyback converter 18 is configured as an isolated DC/DC converter, and performs DC/DC conversion, that is, converts an input voltage VIN, which is a DC voltage, into an output voltage VOUT, which is a DC voltage. Here, an insulating DC/DC converter may be one used in an application where the input voltage VIN is generated by rectifying and smoothing an AC voltage.

As shown in FIG. 9, the flyback converter 18 includes a power control device 1, a transformer 15, a rectifying diode 16, and a smoothing capacitor 17. The power control device 1 is a semiconductor device (semiconductor package) having the internal circuit elements shown in FIG. 9 integrated into a single chip. The transformer 15, the rectifying diode 16, and the smoothing capacitor 17 are discrete circuit elements that are arranged outside the power control device 1.

The power control device 1 includes a differential circuit 2, a resistor 3, a switch 4, a sampling timing feeder 5, a capacitor 6, an error amplifier 7, a capacitor 8, a comparator 9, a current sense resistor 10, an oscillator 11, a flip-flop 12, a driver 13, and a switching element 14. The switching element 14 may be externally connected to the power control device.

The power control device 1 further has, as external terminals for electrical connection with the outside, a VH terminal, a VDS terminal, and a DRAIN terminal.

The VH terminal is connected to an application terminal for the input voltage VIN. The transformer 15 has a primary winding 15A and a secondary winding 15B. One terminal of the primary winding 15A is connected to the application terminal for the input voltage VIN. The other terminal of the primary winding 15A is, along with the DRAIN terminal, connected to the VDS terminal.

One terminal of the secondary winding 15B is connected to the anode of the rectifying diode 16. The cathode of the rectifying diode 16 is, along with one terminal of the smoothing capacitor 17, connected to an output terminal To. The other terminal of the secondary winding 15B is, along with the other terminal of the smoothing capacitor 17, connected to a ground terminal Tg. The ground terminal Tg is connected to an application terminal for a ground potential.

The rectifying diode 16 is one example of a rectifying element; instead of the rectifying diode 16, a rectifying diode of which the cathode is connected to the other terminal of the secondary winding and of which the anode is connected to the other terminal of the smoothing capacitor 17 (i.e., the ground terminal Tg) may be used. As a rectifying element, instead of a rectifying diode, a synchronous rectification transistor may be used.

The differential circuit 2 is a circuit that generates and outputs a current I1 commensurate with the difference between the drain voltage VD appearing at the DRAIN terminal (VDS terminal) and the input voltage VIN applied to the VH terminal. The output terminal of the differential circuit 2 and one terminal of the resistor 3 are connected together at a node N1. The other terminal of the resistor 3 is connected to the application terminal for the ground potential. The current I1, while passing through the resistor 3, is subjected to I/V conversion (current-to-voltage conversion) by the resistor 3 to be converted into a pre-sampling feedback voltage V1. The pre-sampling feedback voltage V1 appears at the node N1.

In the stage succeeding the node N1, a sample-and-hold circuit SH is arranged. The sample-and-hold circuit SH includes the switch 4, the sampling timing feeder 5, and the capacitor 6. One terminal of the switch 4 is connected to the node N1. The other terminal of the switch 4 is connected, at a node N2, to one terminal of the capacitor 6. The other terminal of the capacitor 6 is connected to the application terminal for the ground potential. Based on a gate signal VG, the sampling timing feeder 5 generates a sampling timing signal ST to feed it to the switch 4.

When the sampling timing signal ST indicates sampling, the switch 4 is on, so that the nodes N1 and N2 conduct to each other. Thus sampling is performed in which the pre-sampling feedback voltage V1 appears unchanged as the post-sampling feedback voltage V1′ at the node N2. By contrast, when the sampling timing signal ST indicates holding, the switch 4 is off, so that the nodes N1 and N2 are cut off from each other. Thus holding is performed in which the capacitor 6 holds the post-sampling feedback voltage V1′.

The switching controller 1A includes the error amplifier 7, the capacitor 8, the comparator 9, the current sense resistor 10, the oscillator 11, the flip-flop 12, and the driver 13. The switching controller 1A controls the switching of the switching element 14 (turns it on and off) based on the post-sampling feedback voltage V1′.

The inverting input terminal (−) of the error amplifier 7 is fed with the post-sampling feedback voltage V1′ output from the sample-and-hold circuit SH. The non-inverting input terminal (+) of the error amplifier 7 is fed with a reference voltage VREF. The error amplifier 7 amplifies the error between the post-sampling feedback voltage V1′ and the reference voltage VREF and thereby generates an error signal VFB. The output terminal of the error amplifier 7 is connected to one terminal of the capacitor 8. The other terminal of the capacitor 8 is connected to the application terminal for the ground potential.

The non-inverting input terminal (+) of the comparator 9 is fed with the error signal VFB. The current sense resistor 10 performs I/V conversion on the current Ics passing between the drain and source of the switching element 14 and thereby generates a current sense signal VCS. The inverting input terminal (−) of the comparator 9 is fed with the current sense signal VCS. The comparator 9 compares the error signal VFB and the current sense signal VCS to output, as a comparison result, a reset signal VRESET.

The flip-flop 12 is configured as a D flip-flop. The D terminal of the flip-flop 12 is fed with a supply voltage. The clock terminal of the flip-flop 12 is fed with, as a set signal VSET, the oscillation signal output from the oscillator 11. The set signal VSET (oscillation signal) is a pulse signal with a fixed period. The reset terminal of the flip-flop 12 is fed with the reset signal VRESET.

The signal output from the Q output terminal of the a flip-flop 12 is fed to the driver 13. Based on the output signal from the. Q output terminal, the driver 13 generates a gate signal VG. The switching element 14 is configured with an NMOS transistor. The drain (current input terminal) of the switching element 14 is connected to the DRAIN terminal. The source of the switching element 14 is connected to one terminal of the current sense resistor 10. The other terminal of the current sense resistor 10 is connected to the application terminal for the ground potential. The gate signal VG is fed to the gate of the switching element 14.

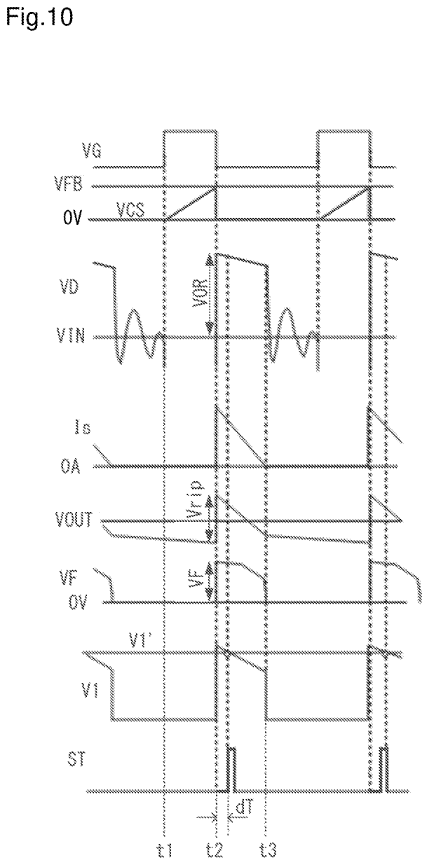

Next, the operation of the flyback converter 18 configured as described above will be described with reference to a timing chart in FIG. 10. FIG. 10 shows an example of the waveforms of, from top down, the gate signal VG, the error signal VFB, the current sense signal VCS, the drain voltage VD, a secondary-side current Is, the output voltage VOUT, a forward voltage VF, the pre-sampling feedback voltage V1, the post-sampling feedback voltage V1′, and the sampling timing signal ST. The secondary-side current Is, as shown in FIG. 9, a current that passes in the secondary winding 15B, and the forward voltage VF is the forward voltage across the rectifying diode 16.

As shown in FIG. 10, when at time point t1 the set signal VSET (not illustrated in FIG. 10) rises, the output from the Q output terminal of the flip-flop 12 rises to high, and the gate signal VG output from the driver 13 rises to high. Thus the switching element 14 is turned on.

Then the drain falls to 0 V, and the current Ics passing through the switching element 14 increases from 0 A. Thus the current sense signal VCS rises from 0 V. Magnetically induced energy is stored in the primary winding 15A, and the rectifying diode 16 is off. In this state, the current I1 output from the differential circuit 2 is 0 A and the pre-sampling feedback voltage V1 is 0 V.

When at time point t2 the current sense signal VCS becomes higher than the error signal VFB, the reset signal VRESET turns low and the flip-flop 12 is reset. Thus the output at the Q output terminal of the flip-flop 12 falls to low and the gate signal VG output from the driver 13 falls to low. Accordingly the switching element 14 is turned off.

Thus the diode 16 turns on and, as shown in FIG. 10, the secondary-side current Is starts to pass (rises from 0 A); hence the magnetically induced energy is released. This produces a flyback voltage VOR in the primary winding 15A. The flyback voltage VOR is given by VOR=(VOUT+VF)×(Np/Ns), where Np is the number of turns of the primary winding 15A and Ns is the number of turns of the secondary winding 15B. As shown in FIG. 10, at time point t2 the secondary-side current Is starts to pass and the forward voltage VF rises from 0 V.

At time point t2 the drain voltage VD rises to VIN+VOR. At this time the differential circuit 2 outputs the current I1 commensurate with the difference between the drain voltage VD and the input voltage VIN and, since VD=VIN+VOR, the current I1 is commensurate with VOR. The pre-sampling feedback voltage V1 equals I1×R1, where R1 is the resistance value of the resistor 3. Accordingly the pre-sampling feedback voltage V1 includes information on the output voltage VOUT, and this permits feedback of the output voltage VOUT in the primary side.

As shown in FIG. 9, the smoothing capacitor 17 includes an ESR (equivalent serial resistance). Thus, as shown in FIG. 10, when at time point t2 the secondary-side current Is starts to pass, the ripple component Vrip appearing in the ESR appears in the output voltage VOUT. The flyback voltage VOR is the sum of the output voltage VOUT, including the ripple component Vrip, and the forward voltage VF.

After time point t2, the secondary-side current Is decreases and accordingly the ripple component Vrip and the forward voltage VF too decrease. Thus, after time point t2, VOR decreases and accordingly the pre-sampling feedback voltage V1 decreases.

When at time point t3 the secondary-side current Is becomes 0 A and ceases to pass, the rectifying diode 16 turns off and the drain voltage VD falls down to the input voltage VIN and then oscillates up and down around the input voltage VIN.

Here, as shown in FIG. 10, the sampling timing feeder 5 raises the sampling timing signal ST to high at a timing delayed by a predetermined time dT from time point t2 at which the gate signal VG falls and the switching element 14 is turned off. This turns the switch 4 on, so that the pre-sampling feedback voltage V1 is sampled and the post-sampling feedback voltage V1′ is output. The sampling timing signal ST thereafter falls to low and the switch 4 is turned off, so that the post-sampling feedback voltage V1′ is held.

The switching controller IA generates the gate signal VG for PWM control such that the post-sampling feedback voltage V1′ equals the reference voltage VREF, and thereby controls the switching of the switching element 14. In this way, the pre-sampling feedback voltage V1 is generated based on the flyback voltage VOR, which includes information on the output voltage VOUT, and based on the post-sampling feedback voltage V1′ resulting from sampling the pre-sampling feedback voltage V1, the switching of the switching element 14 is controlled; thus the output voltage VOUT is controlled.

Inconveniently, the power control device 1 of this comparative example has the following shortcoming: the pre-sampling feedback voltage V1 is sampled at a timing delayed by a predetermined time dT from a fall of the gate signal VG; here, the magnitude of the secondary-side current Is varies with the load and so do the magnitudes of the ripple component Vrip and the forward voltage VF. Thus, performing sampling at a timing based on a predetermined time dT as mentioned above may lead to reduced performance in the control of the output voltage VOUT with respect to the load.

### 2. Determining the Proper Timing of Sampling

Considering the shortcoming mentioned above, in a flyback converter, it is preferable that a feedback voltage based on VOR be sampled at a timing when the ripple component Vrip and the forward voltage VF cease to exert their effect, that is, at a timing when the secondary-side current Is becomes 0 Z and ceases to pass. The timing varies with the magnitude of the load.

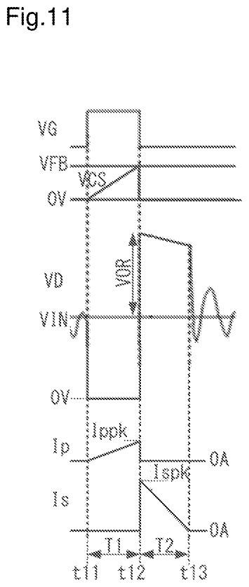

A description will now be given of how to determine the proper timing of sampling as mentioned above. FIG. 11 is a timing chart showing an example of the waveforms of relevant signals in a flyback converter. FIG. 11 shows, from top down, the gate signal VG, the error signal VFB, the current sense signal VCS, the drain voltage VD, a primary-side current Ip, and the secondary-side current Is. The primary-side current Ip is a current that passes in the primary winding.

As shown in FIG. 11, when at time point t11 the gate signal VG rises and the switching element is turned on, the primary-side current Ip starts to pass and increases from 0 A. When at time point t12 the gate signal VG falls and the switching element is turned off, the drain voltage VD rises from 0 V to VIN+VOR. At this time, the primary-side current Ip falls from the peak current value Ippk to 0 A, and the secondary-side current Is rises from 0 A to the peak current value Ispk. After that, the secondary-side current Is decreases and, at time point t13, becomes 0 A and ceases to pass. Here, Formulas (1) and (2) below hold:

Ippk=(T1/Lp)×VIN (1)

Ispk=Ippk×N=(T2/Ls)×VOS (2)

where T1 is the period between time points t11 and t12, T2 is the period between time points t12 and t13, Lp is the inductance of the primary winding, Ls is the inductance of the secondary winding, and N=Np/Ns.

Let the secondary-side voltage be VOS, then VOS=VOUT+VF.

Substituting Formula (1) in Formula (2) gives

(T1/Lp)×VIN×N=(T2/Ls)×VOS (3)

Rearranging Formula (3) with respect to T2 gives

T2=N×(Ls/Lp)×(VIN/VOS)×T1 (4)

Since Ls/Lp=Ns²/Np²,

T2=(Ns/Np)×(VIN/VOS)×T1 (5)

Since VIN, VOR, and T1 (on period) are known and VOR=VOS×(Np/Ns), Formula (5) gives a prediction of the period T2 from a turning-off to the cessation of the secondary-side current Is. Thus, the time point of the end of the period T2 can be determined to be the timing at which to perform sampling.

### 3. Embodiment of the Present Disclosure

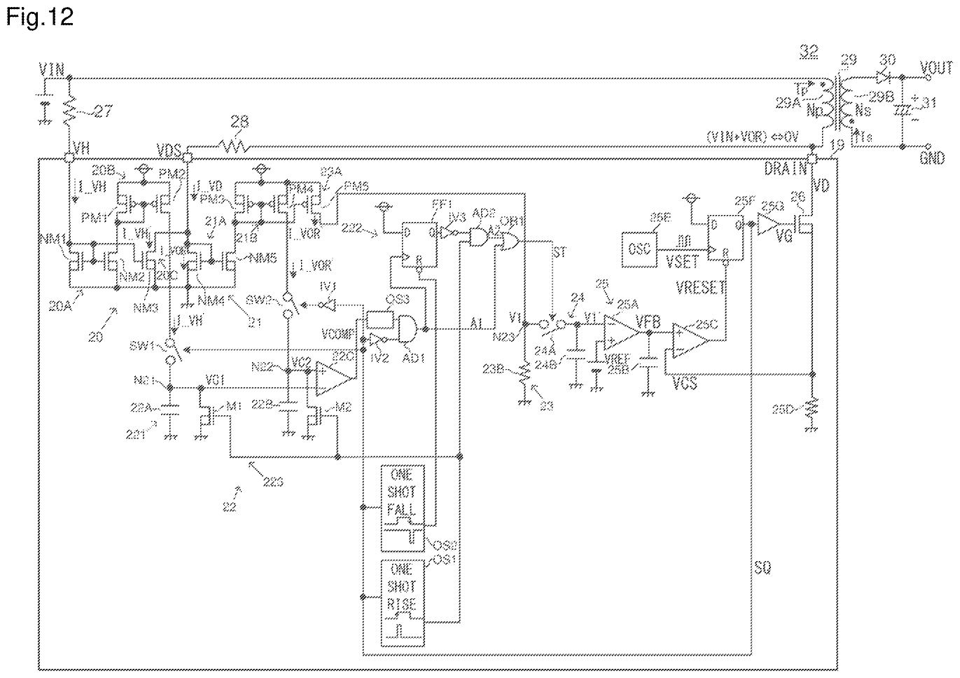

FIG. 12 shows the configuration of a flyback converter 32 according to an embodiment of the present disclosure. The flyback converter 32 includes a power control device 19 that, to address the shortcoming mentioned above, has a function of detecting, as a sampling timing, a time point at which, with a switching element off, the secondary-side current ceases to pass (i.e., a secondary-current zero timing).

As shown in FIG. 12, the flyback converter 32 includes a power control device 19, resistors 27 and 28, a transformer 29, a rectifying diode 30, and a smoothing capacitor 31. The resistors 27 and 28, the transformer 29, the rectifying diode 30, and the smoothing capacitor 31 are discrete circuit elements that are arranged outside the power control device 19. The transformer 29 has a primary winding 29A and a secondary winding 29B. The following description focuses on differences from the flyback converter 32 of the comparative example (FIG. 9).

The power control device 19 includes, integrated in it, an input voltage sense current generator 20, a flyback voltage (VOR) sense current generator 21, a sampling timing feeder 22, a feedback voltage generator 23, a sample-and-hold circuit 24, a switching controller 25, and a switching element 26. The switching element 26 may be arranged outside the power control device.

The power control device 19 also has, as external terminals, a VH terminal, a VDS terminal, and a DRAIN terminal.

### 3-1. Input Voltage Sense Current Generator

The input voltage sense current generator 20 includes current mirrors 20A, 20B, and 20C.

The current mirror 20A is composed of two NMOS transistors NM1 and NM2. Specifically, the drain of the input-side NMOS transistor NM1 is connected to the VH terminal. The gate and drain of the NMOS transistor NM1 are short-circuited together. The source of the NMOS transistor NM1 is connected to an application terminal for a ground potential. The gates of the NMOS transistor NM1 and the output-side NMOS transistor NM2 are connected together. The source of the NMOS transistor NM2 is connected to the application terminal for the ground potential.

The current mirror 20B is composed of two PMOS transistors PM1 and PM2. Specifically the drain of the input-side PMOS transistor PM1 is connected to the drain of the output-side NMOS transistor NM2 in the current mirror 20A. The gate and drain of the PMOS transistor PM1 are short-circuited together. The source of the PMOS transistor PM1 and the source of the output-side PMOS transistor PM2 are both connected to an application terminal for a supply voltage. The gates of the PMOS transistors PM1 and PM2 are connected together. The drain of the PMOS transistor PM2 is connected to one terminal of a switch SW1, which will be described later.

Between the VH terminal and an application terminal for the input voltage VIN, the resistor 27 is arranged. Thus, at the VH terminal (resistor 27) passes a current I_VH=VIN/RD1, where RD1 is the resistance value of the resistor 27. The current I_VH is mirrored by the current mirrors 20A and 20B to be output as an input voltage sense current I_VH′.

The current mirror 20C is composed of two NMOS transistors NM1 and NM3. That is, the input-side NMOS transistor NM1 in the current mirror 20C is shared as the input-side NMOS transistor NM1 in the current mirror 20A. The gates of the NMOS transistor NM1 and the output-side NMOS transistor NM3 are connected together. The source of the NMOS transistor NM3 is connected to the application terminal for the ground potential. Thus the current I_VH is mirrored by the current mirror 20C to be output as an input voltage sense current I_VH″.

### 3-2. VOR Sense Current Generator

A VOR sense current generator 21 includes current mirrors 21A and 21B.

The current mirror 21A is composed of two NMOS transistors NM4 and NM5.

Specifically, the drain of the input-side NMOS transistor NM4 is connected to the VDS terminal. The gate and drain of the NMOS transistor NM4 are short-circuited together. The source of the NMOS transistor NM4 is connected to the application terminal for the ground potential. The gates of the NMOS transistor NM4 and the output-side NMOS transistor NM5 are connected together. The source of the NMOS transistor NM5 is connected to the application terminal for the ground potential.

The current mirror 21B is composed of two PMOS transistors PM3 and PM4. Specifically, the drain of the input-side PMOS transistor PM3 is connected to the drain of the output-side NMOS transistor NM5 in the current mirror 21A. The gate and drain of the PMOS transistor PM3 are short-circuited together. The source of the PMOS transistor PM3 and the source of the output-side PMOS transistor PM4 are both connected to the application terminal for the supply voltage. The gates of the PMOS transistors PM3 and PM4 are connected together. The drain of the PMOS transistor PM4 is connected to one terminal of a switch SW2, which will be described later.

Between a node to which the other terminal of the primary winding 29A and the DRAIN terminal are connected and the VDS terminal, the resistor 28 is arranged. Thus, at the VDS terminal (through the resistor 28) passes a current I_VD=VD/RD2, where RD2 is the resistance value of the resistor 28. The drain of the NMOS transistor NM3 in the current mirror 20C is connected to a node to which the VDS terminal and the drain of the NMOS transistor NM4 are connected. Thus, through the NMOS transistor NM4 passes a differential current I_VOR resulting from subtracting from the current I_VD the current I_VH″.

With the switching element 26 off, the drain voltage VD equals VIN+VOR, and thus the current I_VOR equals I_VD−I_VH″=(VIN+VOR)/RD2−VIN/RD1; thus, assuming that RD1=RD2=RD, the current I_VOR equals VOR/RD. The current I_VOR is mirrored by the current minors 21A and 21B to be output as a VOR sense current I_VOR′.

### 3-3. Sampling Timing Feeder

The sampling timing feeder 22 includes a secondary-current zero timing detector 221, a forced sampling circuit 222, a discharger 223, and an OR circuit OR1.

### 3-3-1. Secondary-Current Zero Timing Detector

The secondary-current zero timing detector 221 includes capacitors 22A and 22B, a comparator 22C, switches SW1 and SW2, inverters IV1 and IV2, an AND circuit AD1, and a rise-sense one-shot circuit OS3.

One terminal of the switch SW1 is, as mentioned above, connected to the drain of the PMOS transistor PM2. The other terminal of the switch SW1 is connected to one terminal of the capacitor 22A. The other terminal of the capacitor 22A is connected to the application terminal for the ground potential. One terminal of the switch SW2 is, as mentioned above, connected to the drain of the PMOS transistor PM4. The other terminal of the switch SW2 is connected to one terminal of the capacitor 22B. The other terminal of the capacitor 22B is connected to the application terminal for the ground potential.

A node N21 to which the switch SW1 and the capacitor 22A are connected is connected to the inverting input terminal (−) of the comparator 22C. A node N22 to which the switch SW2 and the capacitor 22B are connected is connected to the non-inverting input terminal (+) of the comparator 22C.

The comparator 22C compares the capacitor voltage VC1 appearing at the node N21 (across the capacitor 22A) and the capacitor voltage VC2 appearing at the node N22 (across the capacitor 22B) to output, as a comparison result, a comparison signal VCOMP. The comparison signal VCOMP is fed to the rise-sense one-shot circuit OS3. The rise-sense one-shot circuit OS3 outputs a pulse signal that is high for a predetermined period starting at a time point of detection of a rise of the comparison signal VCOMP. The output of the rise-sense one-shot circuit OS3 is fed to one input terminal of the AND circuit AD1. A Q output signal SQ output from the Q output terminal of a flip-flop 25F included in the switching controller 25, which will be described later, is fed via the inverter IV2 to the other input terminal of the AND circuit AD1.

The Q output signal SQ is fed to the switch SW1 and also via the inverter IV1 to the switch SW2. The switches SW1 and SW2 are each on when the signal fed to it is high and off when it is low. Accordingly, when the Q output signal SQ is high, the switch SW1 is on and the switch SW2 is off; when the Q output signal SQ is low, the switch SW1 is off and the switch SW2 is on. Instead of the Q output signal SQ, the gate signal VG may be used; that is, the Q output signal SQ, the gate signal VG, or any other driving signal related to the driving of the switching element 26 may be used.

Here, as a result of the capacitor 22A being charged with the current I_VH′ and the capacitor 22B being charged with the current I_VOR′, two formulae below hold:

I_VH′×T1=C1×VC1 (6)

I_VOR′×T2=C2×VC2 (7)

where T1 is the on period of the switching element 26 and C1 and C2 are the capacitance values of the capacitors 22A and 22B respectively.

Let the off period of the switching element 26 be T2. The off period here is the period from the turning-off of the switching element 26 to the cessation of the secondary-side current Is. Then, since the electric charges represented by the right sides of Formulae (6) and (7) respectively are equal,

I_VH′×T1=I_VOR′×T2 (8)

Rearranging Formula (8) with respect to T2 gives

T2=(I_VH′/I_VOR′)×T1 (9)

Here, since I_VH′=VIN/RD and I_VOR′=VOR/RD Formula (9) can be further modified as follows:

$$\begin{matrix}T 2 = ( VIN / RD ) \times ( RD / VOR ) \times T 1 \\ = ( VIN / RD ) \times ( RD / ( VOS \times N ) ) \times T 1 \\ = ( VIN / VOS ) \times ( Ns / Np ) \times T 1\end{matrix} \qquad ( 10 )$$

Formula (10) is the same as Formula (5) noted previously. Accordingly, when the switching element 26 is on, the switch SW1 is held on and the switch SW2 off, so that the capacitor 22A is charged with the current I_VH′; after the switching element 26 is turned off, the switch SW1 is held off and the switch SW2 on, so that the capacitor 22B is charged with the current I_VOR′. When VC2 becomes such that C1×VC1=C2×VC2, this can be detected with the comparator 22C, and thereby it is possible to detect the time point at which the secondary-side current Is ceases to pass (the zero timing).

Incidentally, with a setting such that C2<C1, when VC2 becomes higher than VC1, this can be detected with the comparator 22C, and thereby it is possible to detect the secondary-side current zero timing.

With the Q output signal SQ low (i.e., with the switching element 26 off), the output of the inverter IV2 is high; this enables the comparison signal VCOMP, which is the output of the comparator 22C, to be output from the AND circuit AD1. The AND output A1, that is, the output of the AND circuit AD1, is fed to one input terminal of the OR circuit OR1. The output of the OR circuit OR1 is taken as the sampling timing signal ST. When VC2 becomes higher than VC1 and the comparison signal VCOMP turns high, the AND output A1 turns high, and thus the sampling timing signal ST turns high. The sampling timing signal ST is fed to a switch 24A in the sample-and-hold circuit 24. When the sampling timing signal ST is high, the switch 24A is on, and the sampling of the pre-sampling feedback voltage V1 is performed as will be described later.

### 3-3-2. Forced Sampling Circuit

The forced sampling circuit 222 includes a flip-flop FF1, an inverter IV3, and AND circuit AD2, a rise-sense one-shot circuit OS1, and a fall-sense one-shot circuit OS2.

The flip-flop FF1 is configured as a D flip-flop. The D terminal of the flip-flop FF1 is fed with the supply voltage. The reset terminal of the flip-flop FF1 is connected to the output terminal of the fall-sense one-shot circuit OS2. The fall-sense one-shot circuit OS2 outputs a pulse signal that is low for a predetermined period starting at the time point of detection of a fall of the Q output signal SQ.

The Q output terminal of the flip-flop FF1. is connected to the input terminal of the inverter IV3. The output terminal of the inverter IV3 is connected to one input terminal of the AND circuit AD2. The other input terminal of the AND circuit AD2 is connected to the output terminal of the rise-sense one-shot circuit OS1. The rise-sense one-shot circuit OS1 outputs a pulse signal that is high for a predetermined period starting at a time point of detection of a rise of the Q output signal SQ. The output terminal of the AND circuit AD2 is connected to the other input terminal of the OR circuit OR1.

Thus, when the Q output signal SQ falls to low and the switching element 26 is turned off, the fall-sense one-shot circuit OS2 outputs a pulse signal, so that the flip-flop FF1 is reset. As a result, the output of the inverter IV3 turns high; this enables the output of the rise-sense one-shot circuit OS1 to be output from the AND circuit AD2. Even if with the switching element 26 off VC2 does not become higher than VC1 and the comparison signal VCOMP does not turn high, at the time point at which the output signal SQ rises to high and the switching element 26 is turned on, the rise-sense one-shot circuit OS1 outputs a pulse signal; thus the AND output A2 of the AND circuit AD2 turns high, and this permits the sampling timing signal ST to be turned high. It is thus possible to perform forced sampling of the pre-sampling feedback voltage V1.

The clock terminal of the flip-flop FF1 is connected to the output terminal of the AND circuit AD1. Thus, when the comparison signal VCOMP is turned high, the Q output of the flip-flop FF1 is turned high and the output of the inverter IV3 is turned low; this disables the output of the rise-sense one-shot circuit OS1 from being output from the AND circuit AD2.

### 3-3-3. Discharger

The discharger 223 includes NMOS transistors M1 and M2 and the rise-sense one-shot circuit OS1. The drain of the transistor M1 is connected to the node N21. The source of the transistor M1 is connected to the application terminal for the ground potential. The drain of the transistor M2 is connected to the node N22. The source of the transistor M2 is connected to the application terminal for the ground potential. The output of the rise-sense one-shot circuit OS1 is fed to the gates of the transistors M1 and M2.

Thus, when the Q output signal SQ rises to high and the switching element 26 is turned on, the rise-sense one-shot circuit OS1 outputs a pulse signal and the transistors M1 and M2 are turned on; this permits the capacitors 22A and 22B to be discharged.

### 3-4. Feedback Voltage Generator

The feedback voltage generator 23 includes current mirrors 21A and 23A and a resistor 23B. The current mirror 21A is shared with the VOR sense current generator 21 described above. The current mirror 23A includes PMOS transistors PM3 and PM5. The PMOS transistor PM3 is shared with the current mirror 21B. The source of the PMOS transistor PM5 is connected to the application terminal for the supply voltage. The gate of the PMOS transistor PM5 is connected to the gate of the PMOS transistor PM3. The drain of the PMOS transistor PM5 is connected to one terminal of the resistor 23B. The other terminal of the resistor 23B is connected to the application terminal for the ground potential.

As in the VOR sense current generator 21 described previously, a current I_VOR is generated as the difference between the currents I_VD and I_VH″. The current I_VOR is mirrored by the current mirrors 21A and 23A to be output as a current I_VOR″. As a result of the current I_VOR″ being subjected to I/V conversion by the resistor 23B, at a node N23 to which the PMOS transistor PM5 and the resistor 23B are connected, the pre-sampling feedback voltage V1 appears. Since I_VOR′=VOR/RD, VC1=(VOR/RD)×R1, where R1 is the resistance value of the resistor 23B.

### 3-5. Sample-and-Hold Circuit

The sample-and-hold circuit 24 incudes a switch 24A and a capacitor 24B. the sample-and-hold circuit 24 has a configuration similar to that of the sample-and-hold circuit SH in the comparative example described previously (FIG. 9). When the sampling timing signal ST is high, the switch 24A is on, and sampling is performed in which the pre-sampling feedback voltage V1 is output unchanged as the post-sampling feedback voltage V1′. When the sampling timing signal ST is low, the switch 24A is off, and holding is performed in which the post-sampling feedback voltage V1′ is held by the capacitor 24B.

### 3-6. Switching Controller

The switching controller 25 includes an error amplifier 25A, a capacitor 25B, a comparator 25C, a current sense resistor 25D, an oscillator 25E, a flip-flop 25F, and a driver 25G. The switching controller 25 has a configuration similar to that of the switching controller 1A in the comparative example described previously (FIG. 9). The switching controller 25 generates the gate signal VG for PWM control such that the post-sampling feedback voltage V1′ equals a reference voltage VREF, and thereby controls the switching of the switching element 26.

### 4. Examples of Operation

Now, examples of the operation of determining the timing of sampling in the power control device 19 configured as described above will be described.

### 4-1. Stable Operation

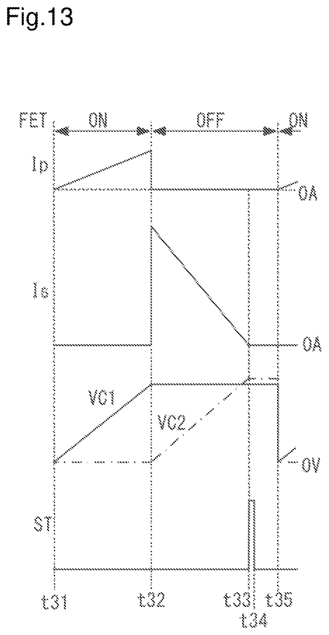

FIG. 13 is a timing chart showing an example of the waveforms of relevant signals during stable operation. FIG. 13 shows, from top down, the on/off state of the switching element 26 (FET), the primary-side current Ip, the secondary-side current Is, the capacitor voltage VC1 (solid line), the capacitor voltage VC2 (dash-and-dot line), and the sampling timing signal ST. In stable operation, as shown in FIG. 13, when the switching element 26 is off, the secondary-side current Is falls down to 0 A.

As shown in FIG. 13, when at time point t31 the Q output signal SQ rises to high and the switching element 26 is turned on, the primary-side current Ip starts to pass. At this time the rise-sense one-shot circuit OS1 outputs a pulse signal and thus the transistors M1 and M2 are both turned on. As a result, the capacitors 22A and 22B are both discharged. Moreover, the Q output signal SQ turns the switch SW1 on and the switch SW2 off, and thus the capacitor 22A starts to be charged with the input voltage sense current I_VH′. As a result, the capacitor voltage VC1 rises from 0 V. Moreover, when the Q output signal SQ is high, the sampling timing signal ST is low, and thus holding is performed.

When at time point t32 the Q output signal SQ falls to low and the switching element 26 is turned off, the primary-side current Ip ceases to pass and the secondary-side current Is starts to pass. At this time the Q output signal SQ turns the switch SW1 off and the switch SW2 on. As a result, the capacitor 22A stops being charged and the capacitor 22B starts to be charged with the VOR sense current I_VOR′.

Moreover, at this time, the fall-sense one-shot circuit OS2 outputs a pulse signal and thereby the flip-flop FF1 is reset; thus the output of the inverter IV3 turns high and this enables the output of the rise-sense one-shot circuit OS1 to be output from the AND circuit AD2. Here, the output of the rise-sense one-shot circuit OS1 is low, and thus the AND output A2 is low. Moreover, the Q output signal SQ turns the output of the inverter IV2 high, and this enables the output signal of the rise-sense one-shot circuit OS3 to be output from the AND circuit AD1. Here, since VC2=0 V and VC2<VC1, the comparison signal VCOMP is low and the AND output A1 is low. Accordingly, the sampling timing signal ST output from the OR circuit OR1 is low, and thus holding is continued.

After that, when at time point t33 VC2 becomes higher than VC1, the comparison signal VCOMP turns high. On sensing the rise of the comparison signal VCOMP to high, the rise-sense one-shot circuit OS3 outputs a high signal; thus the AND output A1 turns high and the sampling timing signal ST turns high. As a result, the switch 24A is turned on, and sampling is performed. Time point t33 is the secondary-side current zero timing.

Moreover, as the AND output A1 turns high, the Q output of the flip-flop FF1 turns high and the output of the inverter IV3 turns low; this disables the output of the rise-sense one-shot circuit OS1 from being output from the AND circuit AD2.

After that, when at time point t34 the output signal of the rise-sense one-shot circuit OS3 falls to low, the AND output A1 turns low. At this time, the Q output of the flip-flop FF1 is kept high, and thus the AND output A2 is low. As a result, the sampling timing signal ST turns low and the switch 24A turns off; thus a switch to holding takes place.

After that, when at time point t35 the Q output signal SQ is raised to high and the switching element 26 is turned on, the output of the inverter IV2 turns low, and thus the AND output A1 turns low. As a result, the Q output of the flip-flop FF1 is kept high and the AND output A2 is low. The sampling timing signal ST output from the OR circuit OR1 is low. As a result, the switch 24A is off, and holding is continued.

Moreover, the NMOS transistors M1 and M2 are now on; thus the capacitors 22A and 22B are discharged and the capacitor voltages VC1 and VC2 both fall to 0 V. Moreover, the primary-side current Ip starts to pass.

As described above, in this embodiment, the time point (zero timing) at which, with the switching element 26 off, the secondary-side current Is ceases to pass in accordance with the load is detected and, at the so detected time point, the pre-sampling feedback voltage V1 is sampled; thus the output voltage VOUT can be controlled using a feedback voltage that is less affected by the ripple component Vrip in the flyback voltage VOR and by the forward voltage VF. It is thus possible to improve the performance in the control of the output voltage VOUT with respect to the load. Moreover, as shown in FIG. 10, once the secondary-side current Is falls to 0 A no VOR occurs, and thus it is preferable not to perform sampling; in light of this, it is possible by using the rise-sense one-shot circuit OS3 to minimize the sampling period (between time points t33 and t34 in FIG. 13).

### 4-2. Unstable Operation

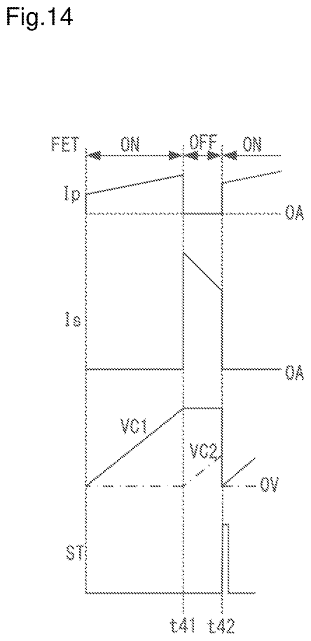

FIG. 14 is a timing chart showing an example of the waveforms of relevant signals during unstable operation. FIG. 14 shows the same signals as FIG. 13. Unstable operation denotes operation observed when, as at start-up, the output voltage VOUT is low and, with the switching element 26 off, the secondary-side current Is does not fall down to 0 A as shown in FIG. 14.

As shown in FIG. 14, as in FIG. 13, with the switching element 26 on, the primary-side current Ip increases and the capacitor voltage VC1 rises as the capacitor 22A is charged. When at time point t41 the switching element 26 is turned off, the primary-side current Ip ceases to pass and the secondary-side current Is starts to pass. When the capacitor 22A stops being charged, the capacitor voltage VC1 stops rising and the capacitor 22B starts to be charged, the capacitor voltage VC2 starting to rise.

In FIG. 14, before at time point t42 the switching element 26 is turned on, VC2 does not become higher than VC1, and thus the AND output A1 remains low. Even so, the Q output signal SQ rising to high at time point t42 makes the rise-sense one-shot circuit OS1 output a pulse signal, and thus the AND output A2 turns high and the sampling timing signal ST turns high. After that, the pulse signal falls to low; thus the AND output A2 turns low and the sampling timing signal ST turns low.

In this way, even if the secondary-side current Is does not fall down to 0 A, when the switching element 26 is turned on, the sampling timing signal ST is turned high, and this makes it possible to forcibly perform the sampling of the pre-sampling feedback voltage V1.

### 5. Modified Example

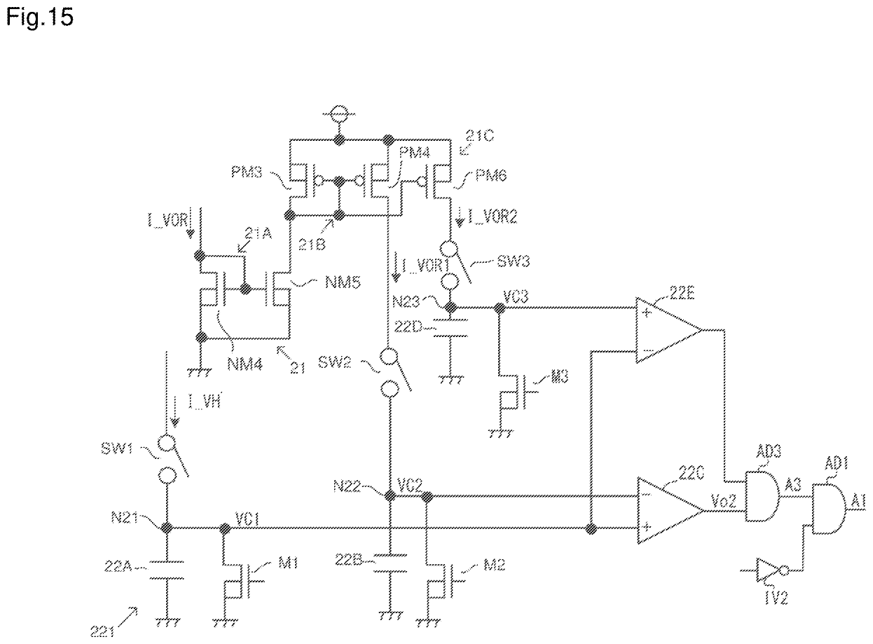

FIG. 15 is a diagram showing a modified example of the configuration related to output of the timing of sampling.

In the configuration shown in FIG. 15, the VOR sense current generator 21 includes, in addition to the current mirrors 21A and 21B (FIG. 12), a current mirror 21C. The current mirror 21C is composed of PMOS transistors PM3 and PM6. The current I_VOR is mirrored by the current minors 21A and 21B to be output as a VOR sense current I_VOR1. The current I_VOR is mirrored also by the current mirrors 21A and 21C to be output as a VOR sense current I_VOR2. The VOR sense currents I_VOR1 and I_VOR2 have the same current value.

Moreover, in the configuration shown in FIG. 15, the secondary-current zero timing detector 221 includes, in addition to the capacitors 22A and 22B, the comparator 22C, the switches SW1 and SW2, the inverters IV1 and IV2, the AND circuit AD1 (FIG. 12), a capacitor 22D, a comparator 22E, a switch SW3, and an AND circuit AD3.

The discharger 223 includes, in addition to the NMOS transistors M1 and M2 and the fall-sense one-shot circuit OS2 (FIG. 12), an NMOS transistor M3.

In this modified example, the polarities of the input terminals of the comparator 22C are reversed as compared with those in the embodiment described previously (FIG. 12). The comparator 22C outputs a comparison signal Vo2.

One terminal of the switch SW3 is connected to the drain of the PMOS transistor PM6. The other terminal of the switch SW3 is connected to one terminal of the capacitor 22D. The other terminal of the capacitor 22D is connected to an application terminal for a ground potential. A node N23 to which the switch SW3 and the capacitor 22D are connected is connected to the non-inverting input terminal (+) of the comparator 22E. The node N21 is connected to the inverting input terminal (−) of the comparator 22E. Thus the comparator 22E compares the capacitor voltage VC3 appearing at the node N23 and the capacitor voltage VC1 appearing at the node N21 to output, as a comparison result, a comparison signal Vo3.

The AND circuit AD3 is fed with the comparison signals Vo3 and Vo2 and outputs an AND output A3. The AND output A3 is fed to one input terminal of the AND output A1.

The drain of the NMOS transistor M3 is connected to the node N23. The source of the NMOS transistor M3 is connected to the application terminal for the ground potential. The gate of the NMOS transistor M3 is, like those of the transistors M1 and M2, driven by the rise-sense one-shot circuit OS1 (FIG. 12).

The switch SW3 is, like the switch SW2, turned on and off by the output of the inverter IV1 (FIG. 12). That is, the switch SW3 is turned on and off synchronously with the switch SW2.

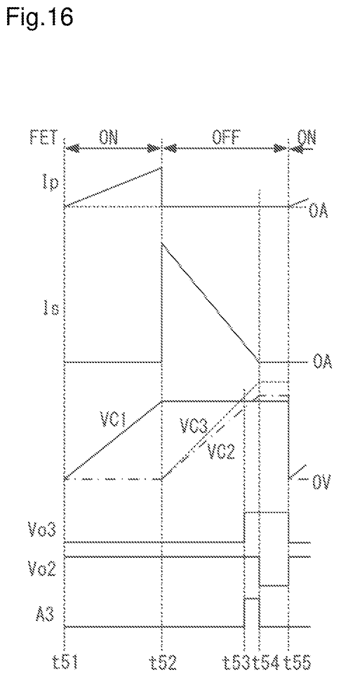

FIG. 16 is a timing chart showing an example of the operation of the configuration of the modified example in FIG. 15. FIG. 16 shows, from top down, the on/off state of the switching element 26 (FET), the primary-side current Ip, the secondary-side current Is, the capacitor voltage VC1 (solid line), the capacitor voltage VC2 (dash-and-dot line), the capacitor voltage VC3 (broken line), the comparison signal Vo3, the comparison signal Vo2, and the AND output A3.

As shown in FIG. 16, when at time point t51 the switching element 26 is turned on, the rise-sense one-shot circuit OS1 turns the transistors M1 to M3 on, and the capacitors 22A, 22B, and 22D are discharged. The switch SW1 is on, and the switches SW2 and SW3 are off. Thus the capacitor 22A starts to be charged and the capacitor voltage VC1 rises. Meanwhile the comparison signal Vo3 is low, the comparison signal Vo2 is high, and the AND output A3 is low. The sampling timing signal ST is low, and thus holding is performed.

After that, when at time point t52 the switching element 26 is turned off, the switch SW1 is off and the switches SW2 and SW3 are on. Thus the capacitor 22A stops being charged and the capacitors 22B and 22D start to be charged. Accordingly the capacitor voltages VC2 and VC3 rise. At this time the comparison signal Vo3 is low, the comparison signal Vo2 is high, and the AND output A3 is low. The sampling timing signal ST is low, and thus holding is performed

Here, the capacitor 22D is given a capacitance slightly lower than that of the capacitor 22B. Consequently, as shown in FIG. 16, the capacitor voltage VC3 rises with a steeper gradient than the capacitor voltage VC2. When the capacitor voltage VC3 rises until at time point t53 it becomes higher than VC1, the comparison signal Vo3 rises to high. Accordingly the AND output A3 rises to high, and thus the AND output A1 rises to high. As a result, the sampling timing signal ST is turned high, and thus sampling is started.

After that, when at time point t54 the capacitor voltage VC2 becomes higher than VC1, the comparison signal Vo2 is dropped to low and the AND output A3 is dropped to low. As a result, the sampling timing signal ST is turned low, and a switch to holding takes place.

After that, when at time point t55 the switching element 26 is turned on, as the capacitors 22A, 22B, and 22D are discharged, the capacitor voltages VC1 to VC3 fall to 0 V. Thereafter, similar operation is repeated.

As described above, with this modified example, using the capacitor voltage VC3 the AND output A3 is raised to high in advance, i.e., at a slightly earlier time point, (t53) to start sampling and, after that, at the time point (t54) at which using the capacitor voltage VC2 the secondary-side current Is is detected to have fallen to 0 A the AND output A3 is dropped to low to end sampling. It is thus possible to place the sampling period immediately before the secondary-side current zero timing and thereby prevent sampling from being performed after the secondary-side current zero timing when no VOR occurs. It is thus possible to perform sampling in a more appropriate period.

### 6. Other Modifications

The embodiments of the present disclosure described above allow for any modifications without departure from the spirit of what is disclosed herein. For example, the resistors 27 and 28 may be incorporated in the power control device 19.

### 7. Notes

As described above, according to one aspect of the present disclosure, a power control device (19) includes: a switching element (26); a transformer (29) having a primary winding (29A) and a secondary winding (29B); a rectifying element (30); and a smoothing capacitor (31).

One terminal of the primary winding is connected to an application terminal for an input voltage (VIN).

The other terminal of the primary winding is connected to the current input terminal of the switching element.

The rectifying element and the smoothing capacitor are provided in a stage succeeding the secondary winding, and the power control device is for use in a flyback converter (32).

Here, the power control device further includes:

a feedback voltage generator (23) which generates a feedback voltage (V1) based on the flyback voltage (VOR) appearing in the primary winding when the switching element is off;
a sample-and-hold circuit (24) which samples the feedback voltage;
a switching controller (25) which controls the switching of the switching element based on the voltage (V1′) output from the sample-and-hold circuit and a reference voltage (VREF); and
a sampling timing feeder (22) which detects, based on the input voltage, the flyback voltage, and the on period of the switching element, the secondary-side current zero timing at which the secondary-side current passing in the secondary winding when the switching element is off ceases to pass and which controls the sample-and-hold circuit based on the secondary-side current zero timing detected. (A tenth configuration.)

In the tenth configuration described above, the sampling timing feeder (22) may include a secondary-side current zero timing detector (221).

The secondary-side current zero timing detector may include:
a first capacitor (22A);
a second capacitor (22B); and
a first comparator (22C) which compares a first capacitor voltage (VC1) appearing across the first capacitor and a second capacitor voltage (VC2) appearing across the second capacitor.

The first capacitor may be charged, when the switching element is on, with an input voltage sense current (I_VH′) based on the input voltage.

The second capacitor may be charged, when the switching element is off, with a flyback voltage sense current (I_VOR′) based on the flyback voltage. (An eleventh configuration.)

In the eleventh configuration described above, the second capacitor (22B) may have a capacitance lower than the capacitance of the first capacitor (22A). (A twelfth configuration.)

In the eleventh or twelfth configuration described above, the secondary-side current zero timing detector (221) may include a first level change sense one-shot circuit (OS3) which outputs a pulse signal on sensing a level change in the output from the comparator (22C). (A thirteenth configuration.)

In the eleventh or twelfth configuration described above, the secondary-side current zero timing detector (221) may include:
a third capacitor (22D);
a second comparator (22E) which compares the first capacitor voltage (VC1) appearing across the first capacitor (22A) and a third capacitor voltage (VC3) appearing across the third capacitor; and
an AND circuit (AD3) which is fed with the outputs of the first comparator (22C) and the second comparator.

The third capacitor may be charged, when the switching element is off, with the flyback voltage sense current (I_VOR2), and

The third capacitor may have a capacitance lower than the capacitance of the second capacitor. (A fourteenth configuration.)

In any of the eleventh to fourteenth configurations described above, there may be further provided:
an input voltage sense current generator (20) which generates the input voltage sense current based on the current passing in a first resistor (27) having one terminal connectable to an application terminal for the input voltage; and
a flyback voltage sense current generator (21) which generates as a differential current (I_VOR) the difference between the current passing in a second resistor (28) having one terminal connectable to the current input terminal and a current based on the current passing in the first resistor and which generates the flyback voltage sense current based on the differential current generated. (A fifteenth configuration.)

In any of the first to fifteenth configurations described above, the sampling timing feeder (22) may include a discharger (223) which discharges the first and second capacitors (22A and 22B) when the switching element turns on. (A sixteenth configuration.)

In the sixteenth configuration described above, the discharger (223) may include:
a second level change sense one-shot circuit (OS1) which outputs a pulse signal on detecting, when the switching element is turned on, a level change in a driving signal related to the driving of the switching element;
a first transistor (M1) which is connected to the first capacitor and which is driven by the pulse signal; and
a second transistor (M2) which is connected to the second capacitor and which is driven by the pulse signal. (A seventeenth configuration.)

In any of the first to seventeenth configurations described above, the sampling timing feeder (22) may forcibly make the sample-and-hold circuit perform sampling when the switching element is turned on even if the secondary-side current zero timing is not detected. (An eighteenth configuration.)

In any of the eleventh to seventeenth configurations described above, the secondary-side current zero timing detector (221) may include a first AND circuit (AD1) which has one input terminal connected to the output terminal of the first comparator (22C) and which has the other input terminal connected to an application terminal for a driving signal related to the driving of the switching element.

The sampling timing feeder (22) may include a forced sampling circuit (222) and an OR circuit OR1).

The forced sampling circuit may include:
a first one-shot circuit (OS2) which outputs a pulse signal on detecting, when the switching element is turned off, a level change in the drive signal;
a flip-flop (FF1) having: a D terminal connected to an application terminal for a supply voltage; a clock terminal connected to the output terminal of the first AND circuit; and a reset terminal connected to the output terminal of the first one-shot circuit;
a second one-shot circuit (OS1) which outputs a pulse signal on detecting, when the switching element is turned on, a level change in the drive signal; and
a second AND circuit (AD2) which has one input terminal connected to the output terminal of the flip-flop and another input terminal connected to the output terminal of the second one-shot circuit.

One input terminal of the OR circuit may be connected to the output terminal of the first AND circuit.

The other input terminal of the OR circuit may be connected to the output terminal of the second AND circuit. (A nineteenth configuration.)

According to another aspect of the present disclosure, a flyback converter (32) includes: the power control device (19) of any of the first to nineteenth configuration described above; the switching element (26); the transformer (29); the rectifying element (30); and the smoothing capacitor (31).

### INDUSTRIAL APPLICABILITY

The present disclosure finds applications in, for example, isolated DC/DC converters or isolated AC/DC converters.

### REFERENCE SIGNS LIST

40, 40′ power control device

401 feedback voltage generator

402 switching controller

41-43 current mirror

41A, 41B NMOS transistor

42A, 42B NMOS transistor

43A, 43B PMOS transistor

44 resistor

45 sample-and-hold circuit

46 error amplifier

47 capacitor

48 comparator

49 I/V converter

50 current sensor

51 oscillator

52 flip-flop

53 driver

54 switching element

55 transformer

55A primary winding

55b secondary winding

56 rectifying diode

57 smoothing capacitor

58, 59 resistor

60, 60′, 601 flyback converter

61 synchronous rectification transistor

62 synchronous rectification controller

1. A power control device, comprising:
a switching element;
a transformer having a primary winding and a secondary winding;
a rectifying element; and
a smoothing capacitor,
one terminal of the primary winding being connected to an application terminal for an input voltage,
another terminal of the primary winding being connected to a current input terminal of the switching element,
the rectifying element and the smoothing capacitor being provided in a stage succeeding the secondary winding,
the power control device being for use in a flyback converter,
wherein
the power control device further comprises:
a feedback voltage generator configured to
generate a differential current that is a difference between
a first current generated by a first resistor having one terminal connectable to the current input terminal and
a second current generated by a second resistor having one terminal connectable to the application terminal for the input voltage and
generate a feedback voltage based on the differential current generated.

2. The power control device according to claim 1, wherein
the feedback voltage generator includes:
a first current mirror
having an input terminal connectable to another terminal of the second resistor and
configured with NMOS transistors;
a second current mirror
having an input terminal connected to an output terminal of the first current mirror and to another terminal of the first resistor and
configured with NMOS transistors;
a third current mirror
having an input terminal connected to an output terminal of the second current mirror and
configured with PMOS transistors; and
a third resistor having one terminal connected to an output terminal of the third current mirror.

3. The power control device according to claim 1, wherein the first and second resistors have equal resistance values.

4. The power control device according to claim 1, wherein the first and second resistors have different resistance values.

5. The power control device according to claim 1, wherein
at least one of the first and second resistors is externally connectable to the power control device.

6. The power control device according to claim 1, wherein
at least one of the first and second resistors is incorporated in the power control device.

7. The power control device according to claim 2, wherein
the third resistor is externally connectable to the power control device.

8. The power control device according to claim 1, further comprising:
a switching controller including a sample-and-hold circuit configured to sample the feedback voltage when the switching element is off,
the switching controller being configured to control switching of the switching element based on a voltage output from the sample-and-hold circuit and a reference voltage.

9. A flyback converter, comprising:
the power control device according to claim 1;
the switching element;
the transformer;
the rectifying element;
the smoothing capacitor; and
the first and second resistors.

10. A power control device, comprising:
a switching element;
a transformer having a primary winding and a secondary winding;
a rectifying element; and
a smoothing capacitor,
one terminal of the primary winding being connected to an application terminal for an input voltage,
another terminal of the primary winding being connected to a current input terminal of the switching element,
the rectifying element and the smoothing capacitor being provided in a stage succeeding the secondary winding,
the power control device being for use in a flyback converter,
wherein
the power control device further comprises:
a feedback voltage generator configured to generate a feedback voltage based on a flyback voltage appearing in the primary winding when the switching element is off;
a sample-and-hold circuit configured to sample the feedback voltage;
a switching controller configured to control switching of the switching element based on a voltage output from the sample-and-hold circuit and a reference voltage; and
a sampling timing feeder configured to
detect, based on the input voltage, the flyback voltage, and an on period of the switching element, a secondary-side current zero timing at which a secondary-side current passing in the secondary winding when the switching element is off ceases to pass and
control the sample-and-hold circuit based on the secondary-side current zero timing detected.

11. The power control device according to claim 10, wherein
the sampling timing feeder includes a secondary-side current zero timing detector, the secondary-side current zero timing detector includes:
a first capacitor;
a second capacitor; and
a first comparator configured to compare a first capacitor voltage appearing across the first capacitor and a second capacitor voltage appearing across the second capacitor,
the first capacitor is charged, when the switching element is on, with an input voltage sense current based on the input voltage, and
the second capacitor is charged, when the switching element is off, with a flyback voltage sense current based on the flyback voltage.

12. The power control device according to claim 11, wherein
the second capacitor has a capacitance lower than a capacitance of the first capacitor.

13. The power control device according to claim 11, wherein
the secondary-side current zero timing detector includes a first level change sense one-shot circuit configured to output a pulse signal on sensing a level change in an output from the comparator.

14. The power control device according to claim 11, wherein
the secondary-side current zero timing detector includes:
a third capacitor;
a second comparator configured to compare the first capacitor voltage appearing across the first capacitor and a third capacitor voltage appearing across the third capacitor; and
an AND circuit configured to be fed with outputs of the first and second comparators,
the third capacitor is charged, when the switching element is off, with the flyback voltage sense current, and
the third capacitor has a capacitance lower than the capacitance of the second capacitor.

15. The power control device according to claim 11, further comprising:
an input voltage sense current generator configured to generate the input voltage sense current based on a current passing in a first resistor having one terminal connectable to an application terminal for the input voltage; and
a flyback voltage sense current generator configured to
generate a differential current that is a difference between a current passing in a second resistor having one terminal connectable to the current input terminal and a current based on the current passing in the first resistor and
generate the flyback voltage sense current based on the differential current generated.

16. The power control device according to claim 11, wherein
the sampling timing feeder includes a discharger configured to discharge the first and second capacitors when the switching element turns on.

17. The power control device according to claim 16, wherein the discharger includes:
a second level change sense one-shot circuit configured to output a pulse signal on detecting, when the switching element is turned on, a level change in a driving signal related to driving of the switching element;
a first transistor connected to the first capacitor and driven by the pulse signal; and
a second transistor connected to the second capacitor and driven by the pulse signal.

18. The power control device according to claim 1, wherein
the sampling timing feeder is configured to forcibly make the sample-and-hold circuit perform sampling when the switching element is turned on even if the secondary-side current zero timing is not detected.

19. The power control device according to claim 11, wherein
the secondary-side current zero timing detector includes a first AND circuit having
one input terminal connected to an output terminal of the first comparator and
another input terminal connected to an application terminal for a driving signal related to driving of the switching element,
the sampling timing feeder includes a forced sampling circuit and an OR circuit,
the forced sampling circuit includes:
a first one-shot circuit configured to output a pulse signal on detecting, when the switching element is turned off, a level change in the drive signal;
a flip-flop having:
a D terminal connected to an application terminal for a supply voltage;
a clock terminal connected to an output terminal of the first AND circuit; and
a reset terminal connected to an output terminal of the first one-shot circuit;
a second one-shot circuit configured to output a pulse signal on detecting, when the switching element is turned on, a level change in the drive signal;
a second AND circuit having
one input terminal connected to an output terminal of the flip-flop and
another input terminal connected to an output terminal of the second one-shot circuit,
one input terminal of the OR circuit is connected to the output terminal of the first AND circuit, and
another input terminal of the OR circuit is connected to an output terminal of the second AND circuit.

20. A flyback converter, comprising:
the power control device according to claim 1;
the switching element;
the transformer;
the rectifying element; and
the smoothing capacitor.
